(19) United States
(12) Patent Application Publication
(10) Pub. No.: US 2026/0017591 A1
(43) Pub. Date: Jan. 15, 2026

(54) SYSTEMS, METHODS, AND STORAGE MEDIA FOR CREATING AND MANAGING A MULTI-TENANT AND MULTI-TIER WORK ARCHITECTURE USING A COMPUTING PLATFORM

(71) Applicant: Radicl Defense, Inc., Boulder, CO (US)

(72) Inventors: Christopher Petersen, Niwot, CO (US); Matthew Petersen, Loveland, CO (US); James Lamar, Thornton, CO (US)

(73) Assignee: Radicl Defense, Inc., Boulder, CO (US)

(21) Appl. No.: 18/771,997

(22) Filed: Jul. 12, 2024

(51) Int. Cl. G06Q 10/0633

(52) U.S. Cl. CPC G06Q 10/0633

(57) ABSTRACT

Systems, methods, and storage media for automated workflow management are disclosed, where the method comprises: identifying, for a protected environment, a plurality of tiers, including at least a first tier and a second tier lower than the first tier; identifying a plurality of tenants operating within the protected environment, where each tenant is associated with one of the plurality of tiers; identifying a plurality of work items (WIs); identifying one or more tasks to be performed for each WI; determining a work type for each WI; automatically assigning each task for each WI to at least one entity, where the assigning is based on determining at least one entity for performing the respective task, and where the determining the at least one entity for each task is based on a tenant and a tier associated with the respective task and/or the respective work item type.

### FIELD OF THE DISCLOSURE

The present disclosure generally relates to a computing platform for creating and managing a multiple-tenant and multiple-tier work architecture. More specifically, but without limitation, the present disclosure relates to systems, methods, and storage media for a multi-tenant and multi-tier managed work architecture configured for operating in an environment, such as a protected environment.

### BACKGROUND

Developing an efficient and effective work management platform can often be a tricky ordeal. This difficulty in assigning and managing work to the right entities (e.g., people, teams, external consultants, people associated with a specific department or a certain role in an organization) becomes more pronounced when a service provider (e.g., cybersecurity company) collaborates with multiple tenants/clients. For instance, when a service provider, such as a SaaS or B2B software company, provides a service to multiple tenants, multiple tiers of work are inherently created. As an example, when a SaaS company offers a service to a client company, there may be some initial work related to onboarding the client company, evaluating IT infrastructure at the client company to see if any hardware and/or software updates are needed to ensure smooth functioning with the SaaS company's software, etc., where some portion of the work may need to be performed by the SaaS company, while the rest may need to be performed by the client company and/or a third-party (e.g., an external consultant). Furthermore, even amongst the work that may need to be performed by the SaaS company, there may be multiple personnel, teams, departments, etc., that may need to be involved. Similarly, multiple personnel, teams, departments, etc., associated with the client company and/or external consultant may be responsible for executing the portion of the work that is performed by the client company (or external consultant).

Currently used work and/or task assignment techniques, especially in a multi-tenant and multi-tier SaaS environment, suffer some deficiencies, including latency or delays in getting the work to the right entities (e.g., personnel, teams, specific team members within a team) at the right time, low efficiency due to rework and/or not relying on data related to similar work performed in the past, inadequate access and/or change control, and/or inadequate recording and analysis of results of the work performed (e.g., to optimize operations). Thus, a refined technique and system for creating and managing a multi-tenant and multi-tier work architecture is needed, which can help overcome one or more of the deficiencies of prior art systems.

The description provided in the background section should not be assumed to be prior art merely because it is mentioned in or associated with the background section. The background section may include information that describes one or more aspects of the subject technology.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

As noted above, currently used work and/or task assignment techniques, especially in a multi-tenant and multi-tier SaaS environment, suffer some deficiencies, including latency or delays in getting the work to the right entities (e.g., personnel, teams, specific team members within a team) at the right time, low efficiency due to rework and/or not relying on data related to similar work performed in the past, inadequate access and/or change control, and/or inadequate recording and analysis of results of the work performed (e.g., to optimize operations). Thus, a refined technique and system for creating and managing a multi-tenant and multi-tier work architecture is needed, which can help overcome one or more of the deficiencies of prior art systems

Broadly, aspects of the present disclosure are directed to systems, methods, and storage media for automated workflow management in a protected environment using a computing platform.

As used herein, the term “protected environment” may be used to refer to one or more of a cybersecurity environment, an internal computing network of an enterprise, Information Technology (IT) infrastructure used by an enterprise, external computing resources (e.g., cloud infrastructure provided by a 3^{rd} party cloud services provider) utilized by the enterprise, supply chain and/or logistics infrastructure, and/or computing devices (e.g., smart phones, laptops, desktops, etc.) utilized by employees and/or contractors of an enterprise, to name a few non-limiting examples.

As used herein, the term “entity” may be used to refer to one or more of a person or user (e.g., John Doe), a team (e.g., associated with a single tenant tier, associated with multiple tenant tiers), team members, a user account (e.g., login information, user credential, service account, or any other applicable account utilized by one or more users), an end user system (e.g., a computing device, such as, but not limited to a laptop, a smartphone, a tablet computer, and a desktop), a server (e.g., a physical machine, a virtual machine), a service (e.g., Software as a Service (SaaS), a cloud service), Indicators of Compromise or IoC devices (e.g., human machine interface or HMI, control systems, etc.), and/or an Internet of Things or IoT device (e.g., a Wi-Fi enabled printer, a smart fridge, a smart thermostat, a voice and/or gesture controlled personal assistant device, a smart speaker, a smart TV, to name a few non-limiting examples).

In some aspects, the techniques described herein relate to a system configured for automated workflow management in a protected environment using a computing platform, the system including one or more hardware processors configured by machine-readable instructions to: identify, for the protected environment, a plurality of tiers, including at least a first tier and a second tier lower than the first tier; identify a plurality of tenants operating within the protected environment, wherein each of the plurality of tenants is associated with one of the plurality of tiers; identify a plurality of work items (Wis); identify one or more tasks to be performed for each work item (WI); determine, for each of the plurality of Wis, at least a work item type; and automatically assign each of the one or more tasks for each of the plurality of Wis to at least one entity, wherein the assigning is based at least in part on: determining, for each of the one or more tasks, at least one entity for performing the respective task, wherein the determining the at least one entity for each of the one or more tasks is based on one or more of a tenant and a tier associated with the respective task, the respective work item type, or a combination thereof.

In some aspects, the techniques described herein relate to a system, wherein the automatically assigning each of the one or more tasks to the at least one entity includes assigning each task to one of: a respective tenant of the plurality of tenants, a team associated with a respective one of the plurality of tiers, a team associated with a respective one of the plurality of tenants, a plurality of entities, including a first entity associated with the first tier and a second entity associated with the second tier, or a specific entity associated with a respective one of the plurality of tenants.

In some aspects, the techniques described herein relate to a system, wherein the one or more hardware processors are further configured to: automatically record results of work performed, based at least in part on tracking one or more task metrics for each of the one or more tasks.

In some aspects, the techniques described herein relate to a method for automated workflow management in a protected environment using a computing platform, including: identifying, for the protected environment, a plurality of tiers, including at least a first tier and a second tier lower than the first tier; identifying a plurality of tenants operating within the protected environment, wherein each of the plurality of tenants is associated with one of the plurality of tiers; identifying a plurality of work items (Wis); identifying one or more tasks to be performed for each work item (WI); determining, for each of the plurality of Wis, at least a work item type; automatically assigning each of the one or more tasks for each of the plurality of Wis to at least one entity, wherein the assigning is based at least in part on: determining, for each of the one or more tasks, at least one entity for performing the respective task, wherein the determining the at least one entity for each of the one or more tasks is based on one or more of a tenant and a tier associated with the respective task, the respective work item type, or a combination thereof.

In some aspects, the techniques described herein relate to a method, wherein the automatically assigning each of the one or more tasks to the at least one entity includes assigning each task to one of: a respective tenant of the plurality of tenants, a team associated with a respective one of the plurality of tiers, a team associated with a respective one of the plurality of tenants, a plurality of entities, including a first entity associated with the first tier and a second entity associated with the second tier, or a specific entity associated with a respective one of the plurality of tenants.

In some aspects, the techniques described herein relate to a method, further including automatically recording results of work performed, based at least in part on tracking one or more task metrics for each of the one or more tasks.

In some aspects, the techniques described herein relate to a method, further including identifying, for at least one task, one or more tasks that are related to or dependent on the at least one task.

In some aspects, the techniques described herein relate to a method, further including creating, using the computing platform, a plurality of libraries, wherein each of the plurality libraries includes at least one work item template (WIT) associated with at least one work item type; and assigning at least one of the plurality of libraries to each of the plurality of tiers.

In some aspects, the techniques described herein relate to a method, further including: creating, using the computing platform, a base WIT, wherein the base WIT is associated with a plurality of properties or features; and constructing, using the computing platform, the at least one WIT for at least one of the plurality of libraries, wherein constructing the at least one WIT for the at least one of the plurality of libraries includes: extracting the plurality of properties or features from the base WIT, and creating the at least one WIT, based on the extracting.

In some aspects, the techniques described herein relate to a method, wherein the at least one WIT inherits the plurality of properties or features from the base WIT.

In some aspects, the techniques described herein relate to a method, wherein, the at least one WIT includes a first WIT and a second WIT, the first WIT associated with a first WI of the plurality of Wis, the second WIT associated with a second WI of the plurality of Wis, the first WI including a first child WI, and the second WI including a second child WI.

In some aspects, the techniques described herein relate to a method, wherein the first WI is associated with a first work type and the second WI is associated with a second work type that is different from the first work type, and wherein the first child WI is associated with the first work type, and wherein the second child WI is associated with a third work type that is different from each of the first and second work types.

In some aspects, the techniques described herein relate to a method, further including automatically assigning each of the plurality of Wis to one of a tier, a team, or a tenant.

In some aspects, the techniques described herein relate to a method, wherein each of the plurality of tiers includes one of a Platform tier, a virtual Security Operations Center (vSOC) tier, or an Enterprise tier, and wherein each of the plurality of tiers is associated with a plurality of work item types.

In some aspects, the techniques described herein relate to a method, wherein, the plurality of the work item types associated with the Platform tier include threat detection content, workflow content, security awareness training content, and data onboarding content.

In some aspects, the techniques described herein relate to a method, wherein the plurality of work item types associated with the vSOC tier include threat detection content, workflow content, security awareness training content, threat investigation, incident response, enterprise resiliency, and data onboarding content.

In some aspects, the techniques described herein relate to a method, wherein the plurality of work item types associated with the Enterprise tier include threat investigation, incident response, human resources (HR) inquiries, legal mqumes, system administration, network administration, and user administration.

In some aspects, the techniques described herein relate to a method, further including automatically creating, using the computing platform, one or more work item templates (WITs), wherein each WIT includes data for creating at least one work item (WI), and wherein each WIT is selected from a group consisting of a task, an assessment, and a remediation.

In some aspects, the techniques described herein relate to a method, wherein the one or more WITs includes a first WIT and a second WIT, the method further including: identifying a link between the first WIT and the second WIT, wherein the link includes one of a parent-child link, a dependency link, and a reference link.

In some aspects, the techniques described herein relate to a non-transient computer-readable storage medium having instructions embodied thereon, the instructions being executable by one or more processors to perform a method for automated workflow management in a protected environment using a computing platform, the method including: identifying, for the protected environment, a plurality of tiers, including at least a first tier and a second tier lower than the first tier; identifying a plurality of tenants operating within the protected environment, wherein each of the plurality of tenants is associated with one of the plurality of tiers; identifying a plurality of work items (Wis); identifying one or more tasks to be performed for each work item (WI); determining, for each of the plurality of Wis, at least a work item type; automatically assigning each of the one or more tasks for each of the plurality of Wis to at least one entity, wherein the assigning is based at least in part on: determining, for each of the one or more tasks, at least one entity for performing the respective task, wherein the determining the at least one entity for each of the one or more tasks is based on one or more of a tenant and a tier associated with the respective task, the respective work item type, or a combination thereof.

In some aspects, the techniques described herein relate to a non-transient computer-readable storage medium, wherein the method further includes automatically recording results of work performed, based at least in part on tracking one or more task metrics for each of the one or more tasks.

In some aspects, the techniques described herein relate to a non-transient computer-readable storage medium, wherein the method further includes creating, using the computing platform, a plurality of libraries, wherein each of the plurality libraries includes at least one work item template (WIT) associated with at least one work item type; and assigning at least one of the plurality of libraries to each of the plurality of tiers.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for creating and managing a multi-tenant and multi-tier managed work architecture, in accordance with various aspects of the disclosure.

FIG. 2A illustrates a first method for creating and managing a multi-tenant and multi-tier managed work architecture, in accordance with various aspects of the disclosure.

FIG. 2B illustrates a second method for creating and managing a multi-tenant and multi-tier managed work architecture, in accordance with various aspects of the disclosure.

FIG. 2C illustrates a third method for creating and managing a multi-tenant and multi-tier managed work architecture, in accordance with various aspects of the disclosure.

FIG. 2D illustrates a fourth method for creating and managing a multi-tenant and multi-tier managed work architecture, in accordance with various aspects of the disclosure.

FIG. 2E illustrates a fifth method for creating and managing a multi-tenant and multi-tier managed work architecture, in accordance with various aspects of the disclosure.

FIG. 2F illustrates a sixth method for creating and managing a multi-tenant and multi-tier managed work architecture, in accordance with various aspects of the disclosure.

FIG. 3 illustrates a block diagram of a system configured for supporting a multiple-tenant and multiple-tier managed work architecture, according to various aspects of the disclosure.

FIG. 4 illustrates a block diagram showing various modules of a system, such as, the system(s) described in relation to FIGS. 1 and/or 3, according to various aspects of the disclosure.

FIG. 5 illustrates another block diagram of a computing platform or system configured for supporting a multiple-tenant and multiple-tier managed work architecture, according to various aspects of the disclosure.

FIG. 6 illustrates an example of a user interface (UI) dashboard displayed on a computing device, according to various aspects of the disclosure.

FIG. 7 illustrates another example of a UI dashboard displayed on a computing device, according to various aspects of the disclosure.

FIG. 8 illustrates another example of a UI displayed on a computing device, according to various aspects of the disclosure.

FIG. 9 illustrates another example of a UI displayed on a computing device, according to various aspects of the disclosure.

FIG. 10 illustrates a diagrammatic representation of a computer system configured for creating and managing a multi-tenant and multi-tier managed work architecture in a protected environment using a computing platform, in accordance with various aspects of the disclosure.

FIG. 11 illustrates an example of a process flow in a multiple-tenant and multiple-tier managed work architecture, according to various aspects of the disclosure.

FIG. 12 illustrates a block diagram showing various examples of task management objects that can be supported by any of the systems described herein, including at least the systems described in relation to FIGS. 1, 3, and/or 5, according to various aspects of the disclosure.

FIG. 13 illustrates examples of various work item types and acceptable state values for different properties/features for each work item type, in accordance with various aspects of the disclosure.

FIG. 14A is directed to the relation between different work item group (WIG) super statuses, WIG statuses, and WI business logics, in accordance with various aspects of the disclosure.

FIG. 14B illustrates examples of various WIG types and WI types, in accordance with various aspects of the disclosure.

FIGS. 14C, 14D, 14E, 14F, and 14G illustrate various relationships between different states and WIG statuses, according to various aspects of the present disclosure.

FIGS. 15A, 15B, 15C, 15D, 15E, 15F, 15G, and 15H are each directed to a different task group (TG) of a larger New Customer Onboarding Project and present information related to the various tasks within each TG, as well as the teams assigned to perform the various tasks, according to various aspects of the present disclosure.

### DETAILED DESCRIPTION

In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or devices. Accordingly, example aspects may take the form of a hardware implementation, a software implementation, or an implementation combining software and hardware aspects. The following detailed description is therefore not to be taken in a limiting sense, and the scope of the present disclosure is defined by the appended claims and their equivalents.

The words “for example” is used herein to mean “serving as an example, instant, or illustration.” Any embodiment described herein as “for example” or any related term is not necessarily to be construed as preferred or advantageous over other embodiments. Additionally, a reference to a “device”, “computing device”, mobile device”, “IoT device”, is not meant to be limiting to a single such device. It is contemplated that numerous devices may comprise a single “device” as described herein.

The embodiments described below are not intended to limit the disclosure to the precise form disclosed, nor are they intended to be exhaustive. Rather, the embodiment is presented to provide a description so that others skilled in the art may utilize its teachings. Technology continues to develop, and elements of the described and disclosed embodiments may be replaced by improved and enhanced items, however the teaching of the present disclosure inherently discloses elements used in embodiments incorporating technology available at the time of this disclosure.

The detailed descriptions which follow are presented in part in terms of algorithms and symbolic representations of operations on data within a computer memory where such data often represents numerical quantities, alphanumeric characters or character strings, logical states, data structures, or the like. A computer generally includes one or more processing mechanisms for executing instructions, and memory for storing instructions and data.

When a general-purpose computer has a series of machine-specific encoded instructions stored in its memory, the computer executing such encoded instructions may become a specific type of machine, namely a computer particularly configured to perform the operations embodied by the series of instructions. Some of the instructions may be adapted to produce signals that control operation of other machines and thus may operate through those control signals to transform materials or influence operations far removed from the computer itself. These descriptions and representations are the means used by those skilled in the data processing arts to convey the substance of their work most effectively to others skilled in the art.

The term algorithm as used herein, and generally in the art, refers to a self-consistent sequence of ordered steps that culminate in a desired result. These steps are those requiring manipulations of physical quantities. Usually, though not necessarily, these quantities take the form of electrical or magnetic pulses or signals capable of being stored, transferred, transformed, combined, compared, and otherwise manipulated. It is often convenient for reasons of abstraction or common usage to refer to these signals as bits, values, symbols, characters, display data, terms, numbers, or the like, as signifiers of the physical items or manifestations of such signals. It should be borne in mind, however, that all of these and similar terms are to be associated with the appropriate physical quantities and are merely used here as convenient labels applied to these quantities.

Some algorithms may use data structures for both inputting information and producing the desired result. Data structures facilitate data management by data processing systems and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation. By changing the organization and operation of data structures and the algorithms for manipulating data in such structures, the fundamental operation of the computing system may be changed and improved.

In the descriptions herein, operations and manipulations are often described in terms, such as comparing, sorting, selecting, or adding, which are commonly associated with mental operations performed by a human operator. However, it should be understood that these terms are employed to provide a clear description of an embodiment of the present disclosure, and no such human operator is necessary.

This requirement for machine implementation for the practical application of the algorithms is understood by those persons of skill in this art as not a duplication of human thought, rather as significantly more than such human capability. Useful machines for performing the operations of one or more embodiments of the present invention include general purpose digital computers or other similar devices. In all cases, the distinction between the method operations in operating a computer and the method of computation itself should be recognized. One or more embodiments of the present disclosure relate to methods and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher-level coding of the instructions that is interpreted to obtain the actual computer code. The software module may also include a hardware component, wherein some aspects of the algorithm are performed by the circuitry itself rather than a result of an instruction.

Some embodiments of the present disclosure rely on an apparatus for performing disclosed operations. This apparatus may be specifically constructed for the required purposes, or it may comprise a general purpose or configurable device, such as a computer selectively activated or reconfigured by a program comprising instructions stored to be accessible by the computer. The algorithms presented herein are not inherently related to any particular computer or other apparatus unless explicitly indicated as requiring particular hardware. In some cases, the computer programs may communicate or interact with other programs or equipment through signals configured to particular protocols which may or may not require specific hardware or programming to accomplish. In particular, various general-purpose machines may be used with programs written in accordance with the teachings herein, or it may prove more convenient to construct more specialized apparatus to perform the required method steps. The required structure for a variety of these machines will be apparent from the description below.

In the following description, several terms which are used frequently have specialized meanings in the present context.

In the description of embodiments herein, frequent use is made of the terms server, client, and client/server architecture. In this context, a server and client are each instantiations of a set of functions and capabilities intended to support distributed computing. These terms are often used to refer to a computer or computing machinery, yet it should be appreciated that the server or client function is provided by machine execution of program instructions, threads, modules, processes, or applications. The client computer and server computer are often, but not necessarily, geographically separated, although the salient aspect is that client and server each perform distinct, but complementary functions to accomplish a task or provide a service. The client and server accomplish this by exchanging data, messages, and often state information using a computer network, or multiple networks. It should be appreciated that in a client/server architecture for distributed computing, there are typically multiple servers and multiple clients, and they do not map to each other and further there may be more servers than clients or more clients than servers. A server is typically designed to interact with multiple clients.

In networks, bi-directional data communication (i.e., traffic) occurs through the transmission of encoded light, electrical, or radio signals over wire, fiber, analog, digital cellular, Wi-Fi, or personal communications service (PCS) media, or through multiple networks and media connected by gateways or routing devices. Signals may be transmitted through a physical medium such as wire or fiber, or via wireless technology using encoded radio waves. Much wireless data communication takes place across cellular systems using second generation technology such as code-division multiple access (CDMA), time division multiple access (TDMA), the Global System for Mobile Communications (GSM), Third Generation (wideband or 3G), Fourth Generation (broadband or 4G), Fifth Generation (5G), personal digital cellular (PDC), or through packet-data technology over analog systems such as cellular digital packet data (CDPD).

### High-Level Details and General Concepts of Disclosure

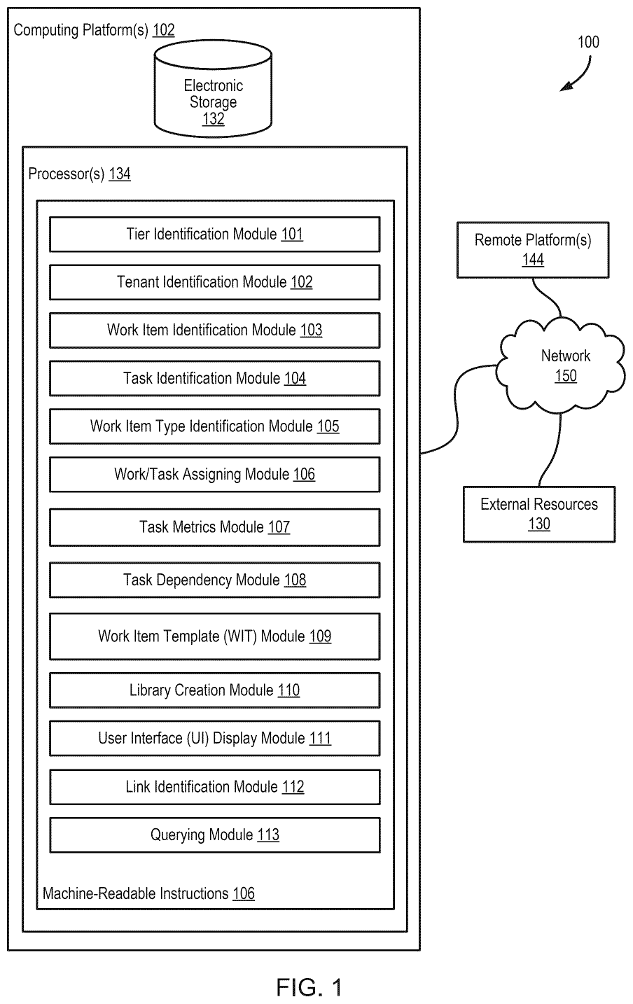

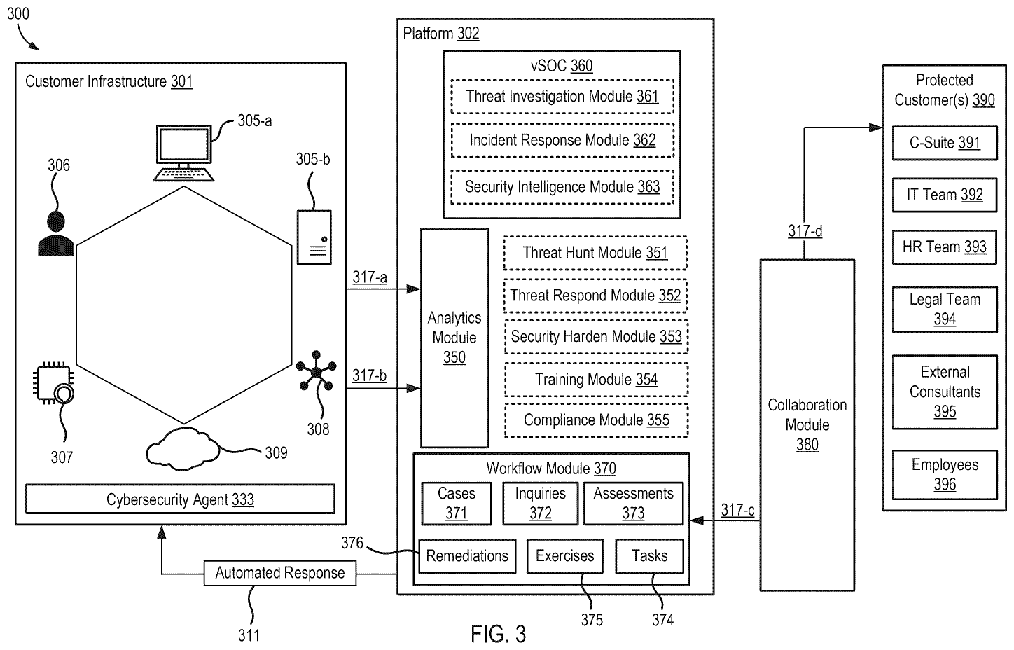

Broadly, aspects of the present disclosure are directed to systems, methods, and storage media for creating and managing a multi-tenant and multi-tier work architecture using a computing platform (e.g., computing platform 102 in FIG. 1, computing platform 302 in FIG. 3).

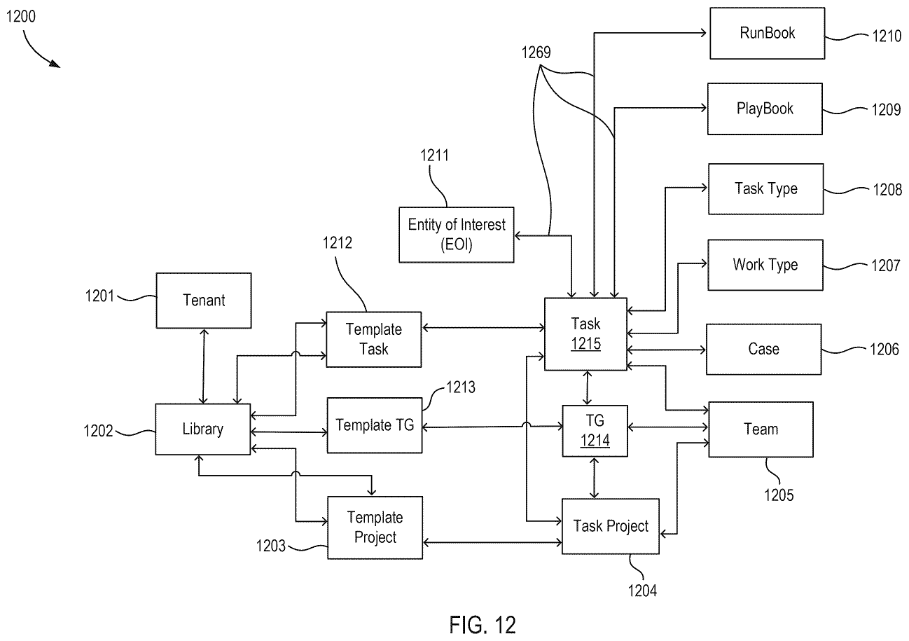

In some embodiments, work management tiers can be defined in the computing platform. Furthermore, each work management tier can have unique work types. In some cases, each tier (e.g., work management tier) can have unique work types. In some cases, each tier can contain libraries (e.g., library 1202 in FIG. 12) that contain pre-fabricated Work Items (Wis) of various types (e.g., work types). In some cases, there is an inheritance model where a Base WI object can be defined/created that implements the shared properties/features, and where Inherited Wis can be constructed that have properties and features unique to that work type. However, all the Inherited Wis may include the capabilities of the Base WI.

In some embodiments, Work Items or Wis are assigned a distinct work type. Furthermore, Work Items can contain child Work Items (i.e., sub-tasks), that can themselves contain Child Work Items. Children Wis can be assigned the same or different work type than their Parent Work Item.

In some embodiments, Tenant Tiers contain Teams. In some embodiments, Teams can be automatically created by the platform or system, such as system 100 described with reference to FIG. 1. Alternatively, the system 100 can be configured to create Teams based on receiving user input via a GUI displayed on a computing device (or user device). In either case, Teams can be authorized to execute certain Work Types. Each Work Type may be assigned at least one Team, and one Team may serve as the Default Team. Such a design can help ensure that Work Items assigned a Work Type can always be routed to a Team. Within Teams, Team Members can have specific “Team Rights” that determine access and workflow rights when a Work Item is assigned to the Team. In some cases, a single user can be assigned to one or more Tiers and can have a Tier-specific persona based on assigned roles. Furthermore, users can be assigned as Team Members to Teams within each authorized Tier. In some examples, a user, acting within a Tier, can select a Work Item (WI) from the Library and assign it for execution by a Tenant Tier and/or a Work Management Tier. When assigned, the Work Type associated with the WI may be used to determine the Default Team to assign to the WI. Members of the Team, based on their Team Rights, may be notified of the newly assigned WI and/or may be able to see it become visible in a user interface (UI) displayed on a computing device. In some cases, based on their Team Rights, a Team Member could elect to become the “Owner” of the work (i.e., work item or WI) and/or collaborate with other authorized Team Members on the work. In some cases, a derivation of the above may entail pulling a WI from the Library and assigning it to multiple Tenants, whereby each Tenant (e.g., Tenant 1201 in FIG. 12) receives the identical work but assigned to that Tenant's appropriate Team based on the WI-to-Team association. Another derivation may involve creating ad-hoc Work Items (or ad-hoc Wis), where each of the ad-hoc Wis are assigned a Work Type and assigned one or more Tenants.

In some aspects, the multi-tenant and multi-tier work architecture of the present disclosure supports Wis being assigned and auto-routed to a Parent Tier, the Same Tier, or a Child Tier. One of the principal outcomes of this disclosure is the ability to create a Library of pre-fabricated Wis along with ad-hoc Wis, where the Wis can be assigned to one more Tenants, where the WI gets to the Team Members authorized to do the work, without the user assigning the WI having to understand anything about the assigned Tenant's users. Work (or a WI) is automatically and appropriately assigned based on the assigned Work Type and the association of the Work Type-to-Teams authorized (and the default Team) to do that work. Also, key is the ability to assign Team Rights that can then control what a Team Member is authorized to do with the assigned Work Item (e.g., take ownership of, transfer ownership of, collaborate on, simply view it, etc.).

Another aspect of the multi-tenant and multi-tier work architecture is the ability of a user to change their Tier Context, and immediately (via the UI or API layer) operate within a different Tier in that Tier's persona (based on assigned role/rights). For instance, members of the vSOC Team can be given access to the Platform Tier and shift into this Tier where they may be able to assume the persona of a “Content Engineer”. The member(s) of the vSOC Team can then shift back to the vSOC tier and reassume their role as a “Security Analyst”, which enables the vSOC Team Member to monitor and manage the work of the Tier below them, such as the Enterprise Tier.

### Leverage of AI/Automation

In some cases, Work Item (WI) instances are associated with specific types of Work Areas. Examples include Security Incident Cases, Vulnerability Remediations, and Compliance Assessments. For instance, a Security Incident might have (1) a Work Item that Instructs a user on how to run an interrogation script on the impacted machine, or (2) automatically runs the interrogation script on the impacted Machine. In another example, a Vulnerability Remediation might have a Work Item that (1) Instructs a user how to patch a collection of impacted Machines, and/or (2) Programmatically interfaces with another system, or the Machine itself, to install the necessary patches. In yet another example, a Compliance Assessment might have a Work Item that (1) instructs a user on how to evaluate configuration settings within an information system to see if comply with a given standard, and/or (2) programmatically interfaces with the information system to query the configuration setting and determine whether within compliance norms.

In some embodiments, Wis can contain entities relevant to the Work to be performed. Some non-limiting examples include machines or user accounts thought to be compromised (Security Incident); the vulnerability and threat actor associated with a compromise (Security Incident); the machine(s) and vulnerabilities associated with a Vulnerability Remediation; the cloud service associated with a Compliance Assessment.

Over time and across all Tenants, the Team Members of the vSOC Team can utilize the computing platform or system of the present disclosure to construct new work items (ad-hoc) and leverage existing ones from the Library. In some aspects, the construction and leverage of Wis by vSOC personnel, within Work Areas, in real-world, “live fire” situations will be recorded by the system and leveraged to build/reinforce models that augment/automate workflows.

### AI Work.Flows

Within a Tenant Work Area scenario instance, an AI workflow may comprise predicting and suggest the appropriate Work Item (from a Library) to execute based on similar Work Items executed in past similar situations.

Within a Tenant Work Area scenario instance, an AI workflow may comprise automatically constructing a customized (ad-hoc) Work Item based on similar Work Items executed in past similar situations, and leveraging Entities associated with the Work Item combined with general knowledge (i.e., known information) on the Tenant acquired by AI monitoring/observing their IT infrastructure. In some embodiments, WI construction might also leverage and pull in content from generally available models that contain “AI advise” and synthesize this advice with what the AI model uniquely knows about the Tenant and scenario.

Within a Tenant Work Area scenario instance, an AI workflow may comprise leveraging bespoke or 3P AI models, extracting relevant Entities from the WI and constructing executable code able to automatically achieve the desired WI outcome.

Within a Tenant Work Area scenario, an AI workflow may comprise determining whether to have a human approve automated WI execution or execute without human intervention. In some circumstances, making this decision based on past observed occurrences of similar automated actions, and prior decision approvals, and any recorded negative outcomes. In some instances, relevant risk indicators that influence the urgency of action, which might necessitate/prioritize automated execution may also be infused into the decision.

Across Tenants, and within a Work Area, an AI workflow may compnse suggesting/constructing Wis to be executed within other Tenants based on Tenant and scenario similarity, in support of proactively reducing cyber incident risk.

### Definition of Terms used in the Disclosure

As used herein, the term “protected environment” may be used to refer to one or more of a cybersecurity environment, an internal computing network of an enterprise, Information Technology (IT) infrastructure used by an enterprise, external computing resources (e.g., cloud infrastructure provided by a 3^{rd} party cloud services provider) utilized by the enterprise, supply chain and/or logistics infrastructure, and/or computing devices (e.g., smart phones, laptops, desktops, etc.) utilized by employees and/or contractors of an enterprise, to name a few non-limiting examples. However, it should be noted that other types of protected environments besides the ones listed herein are contemplated in different embodiments.

As used herein, the term “entity” may be used to refer to one or more of a person or user (e.g., John Doe), a Team, a Tenant, Team Members of a Team, a user account (e.g., login information, user credential, service account, or any other applicable account utilized by one or more users), an end user system (e.g., a computing device, such as, but not limited to a laptop, a smartphone, a tablet computer, and a desktop), a server (e.g., a physical machine, a virtual machine), a service (e.g., Software as a Service (SaaS), a cloud service), Indicators of Compromise or IoC devices (e.g., human machine interface or HMI, control systems, etc.), and/or an Internet of Things or IoT device (e.g., a Wi-Fi enabled printer, a smart fridge, a smart thermostat, a voice and/or gesture controlled personal assistant device, a smart speaker, a smart TV, to name a few non-limiting examples).

In some aspects, the present disclosure uses the term “entities” in multiple contexts. For example, the term “entity” can be used to refer to a person, a user, a team, team members within a team, a server or computing device, which can be assigned or configured to perform a work item, a task, etc. In some cases, the entities that can be assigned or configured to perform work (e.g., work items, tasks) can also be referred to as “a first type of entity”, “an entity of a first type”, or “a working entity”, which helps distinguish them from entities that can be included/contained within a work item. In some examples, a work item can contain one or more entities (e.g., an account entity, a weakness, a vulnerability, etc.), and such entities that may be included within a work item (WI) may be referred to as “a second type of entity”, “an entity of a second type”, or “a WI encompassed entity”. In some cases, these second type of entities (or WI encompassed entities) contained within work items can help direct actions of the work items. Some types of entities that can be included within work items (or extracted from work items) can include user device information, user information, user account information, and/or user credentials.

Some non-limiting examples of entities along with their associated properties/features (written in the form Entity/Feature) may include: (1) Threat/Name, (2) Threat/VendorID, (3) Attack/Name, (4) Attack/Description, (5) Attack/VendorID, (6) Attack/Type, (7) Attack/Risk, (8) Attack/Severity, (9) Vulnerability/CVE, (10) Vulnerability/Risk, (11) Vulnerability/Name, (12) Vulnerability/Description, (13) Account/Type, (14) Account/Domain, (15) Account/Usemame, (16) Account/FullUserName, (17) Account/Role, (18) Account/Privilege, (19) Group/Name, (20) Group/Domain, (21) Secret/Type, (22) Secret/Value, (23) Object/Type, (24) Object/Name, (25) Object/Path, (26) Object/Directory, (27) Object/Value, (28) Object/Hash, (29) Service/Name, (30) Service/Protocol, (31) Service/Process, (32) Protocol/Name, (33) Process/Name, (34) Process/ProcessID, (35) Process/ParentName, (36) Location/Zip, (37) Location/Longitude, and (38) Location/Longitude.

Some other types of entities and their associated properties/features may further include: (39) Machine/Type, (40) Machine/IP, (41) Machine/Name, (42) Machine/FullName, (43) Machine/Domain, (44) Machine/MAC, (45) Machine/Service, (46) Machine/Process, (47) Machine/Location, (48) Machine/Attack, and/or (49) Machine/Vulnerability.

Some other types of entities and their associated properties/features may further include: (50) Person/FirstName, (51) Person/MiddleName, (52) Person/LastName, (53) Person/FullName, (54) Person/Phone, (55) Person/Account, (56) Person/Location, (57) Person/Machine, (58) Machine/Location, (59) Machine/Attack, and/or (60) Machine/Vulnerability.

In some cases, each of the entity-feature pairs may be associated with a value type (e.g., string, reference, integer, floating point number, to name a few non-limiting examples). Furthermore, the value for each entity-feature pair may be one of parsed, derived, parsed or derived, and linked. As an example, the value type and determination for the (49) Machine/Vulnerability pair may be referenced and linked, respectively. As another example, the value type and determination for (1) Threat/Name pair may be string and parsed, respectively. In yet another example, the value type and determination for the (36) Location/Zip pair may be integer and parsed, respectively.

Some non-limiting examples of derived/linked values may include Critical, High, Medium, Low, None, for instance, for a risk or severity level of an attack or vulnerability. In another example, the derived values for the Account/Type pair may include user, system, email, or unknown. In some examples, the linked value for a Service/Protocol or Service/Process may be ‘Using’. In some cases, the linked value for the Machine/Vulnerability pair may include ‘Has’ or ‘Lacks’.

It should be noted that the entities and their associated features/properties, value types, derived/link values (where applicable) described herein are exemplary only and not intended to limit the scope and/or spirit of the disclosure. Additionally, it should be noted that other types of entities besides the ones listed herein are contemplated in different embodiments.

In some cases, an entity can be contained within the work item, and can help direct actions of the work item. In some embodiments, each work item or WI can be assigned or associated with a work type. Furthermore, teams can be created to serve/perform work of specific types, at certain tiers. Additionally, when instances of work are created (ad-hoc or from libraries), the work can be auto-routed to the right Teams and their members, in accordance with various aspects of the disclosure.

FIG. 1 illustrates a system 100 configured for creating and managing a multi-tenant and multi-tier managed work architecture using a computing platform, according to various aspects of the present disclosure. In some implementations, system 100 may include one or more computing platform(s) 102. Computing platform(s) 102 may be configured to communicate with one or more remote platforms 144 according to a client/server architecture, a peer-to-peer architecture, and/or other architectures. In some cases, the computing platform 102 may implement one or more aspects of the systems 300, 400, and/or 500 described below in relation to FIGS. 3-5. Remote platform(s) 144 may be configured to communicate with other remote platforms via computing platform(s) 102 and/or according to a client/server architecture, a peer-to-peer architecture, and/or other architectures. In some embodiments, users may access system 100 via remote platform(s) 144. In some examples, the terms “remote computing platform”, “remote platform”, “user device”, and “user equipment” may be used interchangeably throughout the disclosure. Some non-limiting examples of remote platform(s) include laptops, desktop computers, smartphones, and/or tablets.

Computing platform(s) 102 may be configured by machine-readable instructions 106. Machine-readable instructions 106 may include one or more instruction modules. The instruction modules may include computer program modules. The instruction modules may include one or more of tier identification module 101, tenant identification module 102, work item identification module 103, task identification module 104, work item type identification module 105, work/task assigning module 106, task metrics module 107, task dependency module 108, work item template (WIT) module 109, library creation module 110, user interface (UI) display module 111, link identification module 112, querying module 113, and/or other instruction modules. It should be noted that one or more of the instruction modules described herein may be optional. Alternatively, in some embodiments, a single instruction module may be utilized to effectuate the functions of a plurality of instruction modules.

Tier identification module 101 may be configured to identify, for a protected environment, a plurality of tiers, including at least a first tier and a second tier lower than the first tier.

Tenant identification module 102 may be configured to identify a plurality of tenants operating within the protected environment, where each of the plurality of tenants is associated with one of the plurality of tiers.

Work item identification module 103 may be configured to identify a plurality of work items (Wis).

Task identification module 104 may be configured to identify one or more tasks to be performed for each WI.

Work item type identification module 106 may be configured to determine, for each of the plurality of Wis, at least a work item type.

Work/Task assigning module 106 may be configured to automatically assign each of the one or more tasks for each of the plurality of Wis to at least one entity (e.g., a person, a computing device, a team, members of a team, a person with a specific role or title in an organization, a server, etc.). In some embodiments, the assigning is based at least in part on determining, for each of the one or more tasks, at least one entity (e.g., a specific Team, Team Members of a Team) for performing the respective task, where the determining the at least one entity for each of the one or more tasks is based on one or more of a tenant and a tier associated with the respective task, the respective work item type, or a combination thereof.

In some embodiments, the work/task assigning module 106 may be configured to automatically assign each of the plurality of Wis to one of a tier, a team, one or more team members of a team, or a tenant. For example, the work/task assigning module 106 may be configured to automatically route work to the appropriate teams and their members based on the work type.

In some implementations, each of the plurality of tiers comprises one of a Platform tier, a Virtual Security Operations Center (vSOC) tier, or an Enterprise tier. In some examples, each of the plurality of tiers is associated with a plurality of work item types.

In some implementations, the plurality of the work item types associated with the Platform tier include threat detection content, workflow content, security awareness training content, and data onboarding content.

In some implementations, the plurality of work item types associated with the vSOC tier include threat detection content, workflow content, security awareness training content, threat investigation, incident response, enterprise resiliency, and data onboarding content.

In some implementations, the plurality of work item types associated with the Enterprise tier include threat investigation, incident response, human resources (HR) inquiries, legal inquiries, system administration, network administration, and user administration.

In some embodiments, Work Items or Wis are assigned a distinct work type, which can be performed automatically by the system 100 in some embodiments. Furthermore, Work Items can contain child Work Items (i.e., sub-tasks), that can themselves contain Child Work Items. Children Wis can be assigned the same or different work type than their Parent Work Item.

In some embodiments, each tenant tiers (e.g., vSOC tier, Platform tier, Enterprise tier) may contain teams. Teams can be authorized to execute certain work types. In some cases, each work type may be assigned at least one Team, and one Team may serve as the default team. Such a design can help ensure that Wis assigned a work type can always be routed to a Team. Furthermore, within Teams, Team Members can have specific “Team Rights” that determine access and workflow rights when a WI is assigned to the Team.

In some embodiments, automatically assigning each of the one or more tasks or Wis to the at least one entity includes assigning each task or WI to one of (1) a respective tenant of the plurality of tenants, a team associated with a respective one of the plurality of tiers, (2) a team associated with a respective one of the plurality of tenants, (3) a plurality of entities, including a first entity (e.g., a first Team, such as a Security Analyst Team) associated with the first tier (e.g., Platform tier) and a second entity (e.g., a second Team, such as an IT admin team) associated with the second tier (e.g., vSOC tier, or Enterprise tier), or (4) a specific entity (e.g., an internal IT team) associated with a respective one of the plurality of tenants (e.g., an Enterprise). In some embodiments, the plurality of entities may include a first entity (e.g., vSOC Team) associated with a first tier (e.g., vSOC Tier) and a second entity (e.g., Enterprise Team) associated with a second, different tier (e.g., Enterprise Tier). In accordance with aspects of the disclosure, the system 100 can be configured to create Teams, where each Team may serve or perform work of specific work types, at certain tiers. Furthermore, when instances of work are created (ad-hoc or from libraries), the system 100 may be configured to automatically route the work to a Team and its Members.

In some embodiments, an entity may comprise an entity that can be assigned/performs a work item or task, such as a team (e.g., internal IT team associated with a client enterprise, security analyst team associated with the system or platform 100), a team member or user within a team, a user with a specific role or designation (e.g., user with admin privileges working in the human resources (HR) department at a client enterprise), a specific computing device (e.g., computing device with a specific IP address or MAC address), or any other applicable entity. Other types of entities besides the ones described above are contemplated in different embodiments, and the examples listed herein are not intended to limit the scope and/or spirit of the present disclosure.

In some embodiments, the plurality of entities comprises a first set of entities (or internal entities) operating within the protected environment and a second set of entities (or external entities) that are external to the protected environment. In some embodiments, the first set of entities includes one or more entities selected from a group consisting of a Team, Members of the Team, a Tenant, a Tenant Tier containing one or more Teams, and/or a user (e.g., a user assigned to a single Tier, a user assigned to one or more Tiers), to name a few non-limiting examples.

In some embodiments, the second set of entities includes one or more entities selected from a group consisting of a Team, Members of the Team, a Tenant, a Tenant Tier containing one or more Teams, and/or a user (e.g., a user assigned to a single Tier, a user assigned to one or more Tiers), to name a few non-limiting examples.

In some other cases, the first set of entities can further include entities that can be contained/referenced within a work item, such as an email inbox, a user account, a computing device, a server, a virtual machine, and an Internet of Things (loT) device. In some other cases, the second set of entities can further include a cloud service infrastructure associated with at least one cloud service provider, an Information Technology (IT) infrastructure associated with at least one customer or client, and a supply chain IT infrastructure associated with the at least one customer.

In some examples, the system 100 is configured to construct and retain a stateful record of all (or a majority) of the entities within the protected environment, based at least in part on assessing the data and signals flowing in the protected environment. As noted above, the term “entity” can be used to refer to a working entity (e.g., an entity such as a person, a user, a team, team members within a team, a server or computing device, that can be assigned or configured to perform a work item, a task, etc.) or a WI encompassed entity (e.g., an entity that can be contained/referenced within a work item). In some cases, one or more of the entities may be “known entities”, which may refer to entities that have been previously processed or identified by the system 100. Some non-limiting examples of known entities may include a known person or user (e.g., a working entity), a known computing device (e.g., a working entity, or a WI encompassed entity) associated with a known person/user, a known email account (e.g., a WI encompassed entity), a known username (e.g., a WI encompassed entity), a database of known threat actors, known vulnerabilities, known Tactics, Techniques, and Procedures (TTPs), known Indicators of Compromise (IoCs), etc. Furthermore, one or more entities may be “synthetic entities”, which may refer to entities that are not currently known or previously processed by the system 100. In some cases, synthetic entities may be linked or associated with a known entity. As an example, if a known entity (e.g., a person ‘A’) logs into a new laptop (not known) using their email or user account (also known to the system 100), the system may establish a link between the email or user account and the new laptop (e.g., a MAC address of said laptop) and/or a link between the person ‘A’ and the new laptop. In this case, the new laptop may be referred to as a “synthetic entity” based on its link or relationship with a known entity.

In some embodiments, knowledge related to the entities associated with the protected environment may be manually input (e.g., by a system or IT administrator), automatically input or synced, inferred based on data observation, and/or generated via vulnerability scans and security awareness training. In some embodiments, vulnerability scanning and/or security awareness training may be employed to obtain intelligence about the various entities associated with the protected environment.

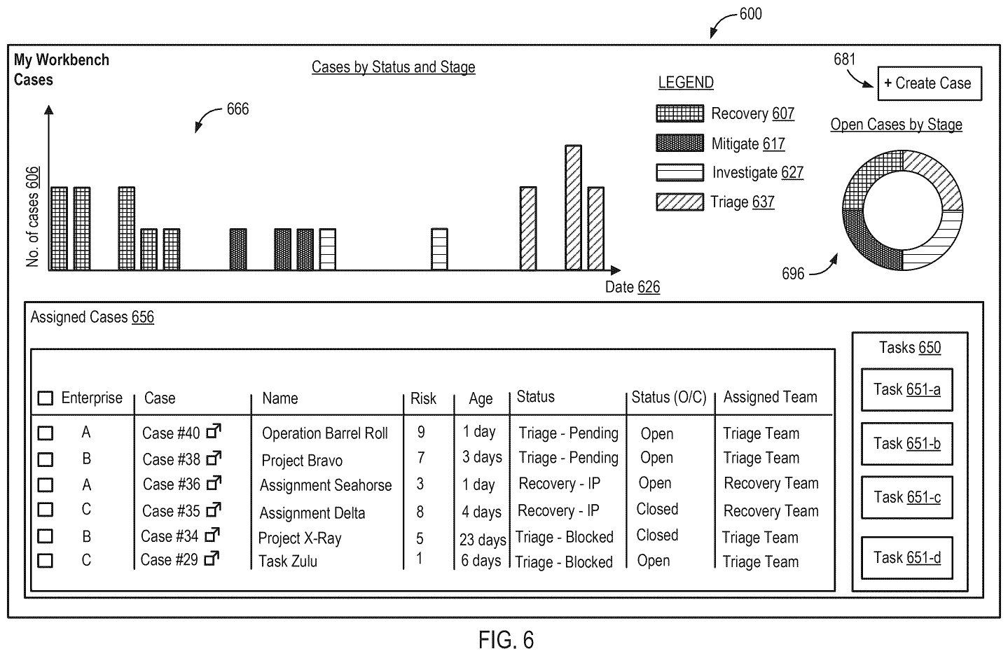

Task metrics module 107 may be configured to track one or more task metrics (e.g., quantitative task metrics, such as those discussed below in relation to FIGS. 6 and/or 7) for each of the one or more tasks. Furthermore, the task metrics module 107 may be configured to automatically record results of work performed by the at least one entity (e.g., assigned Team), based at least in part on tracking one or more task metrics for each of the one or more tasks.

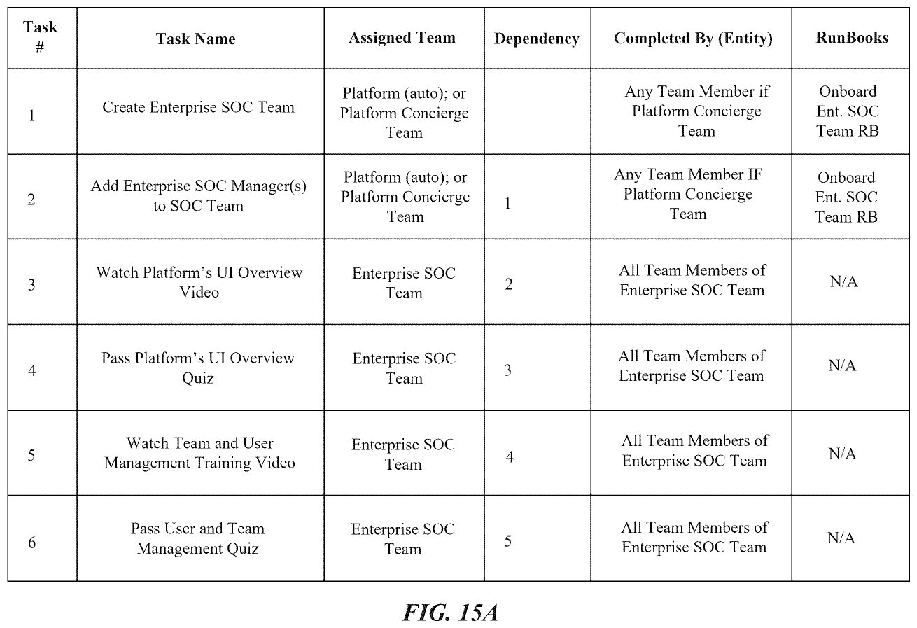

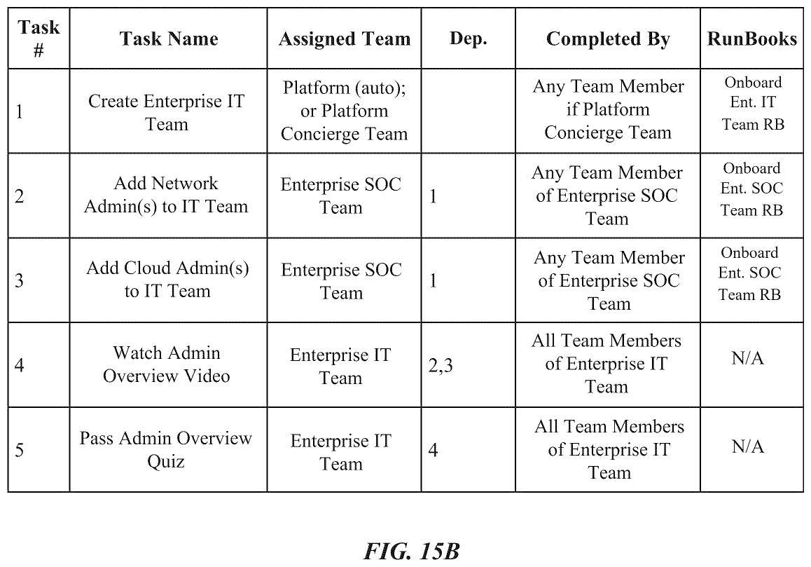

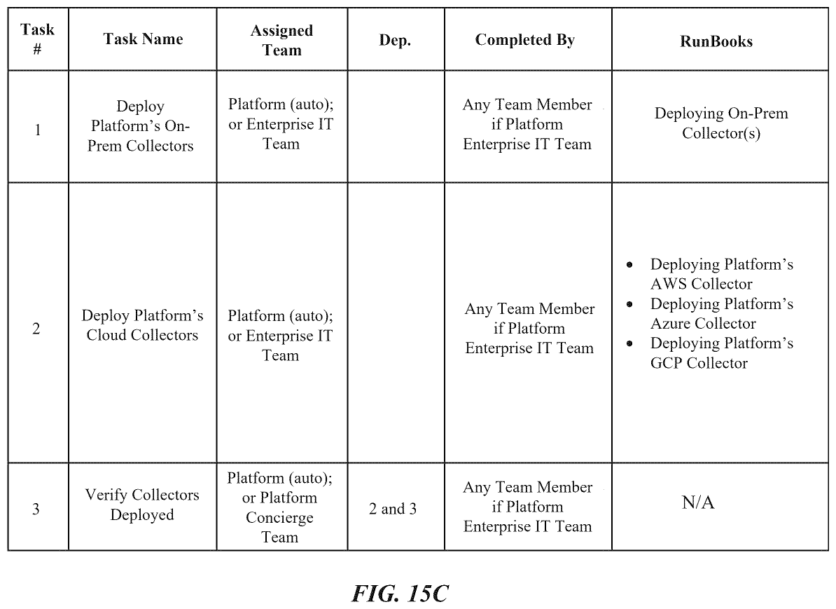

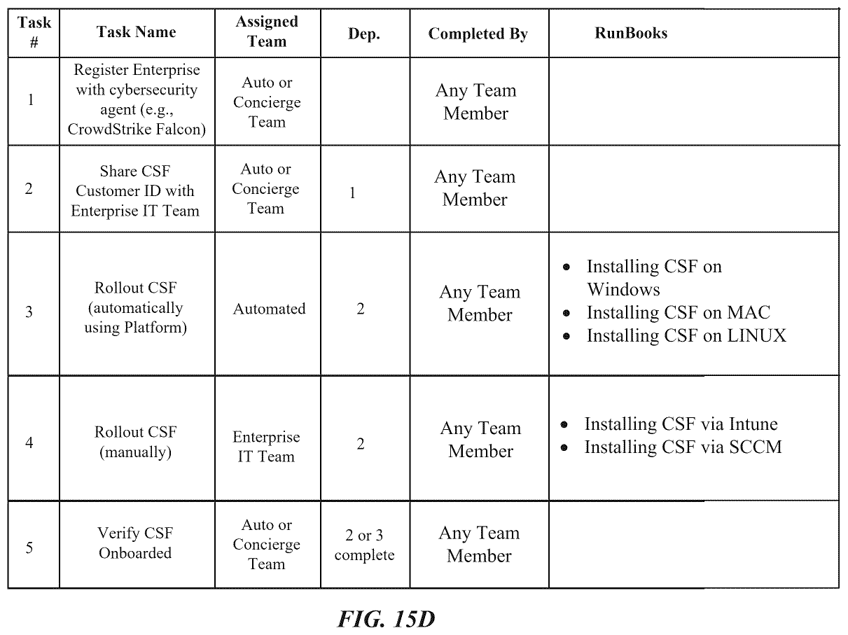

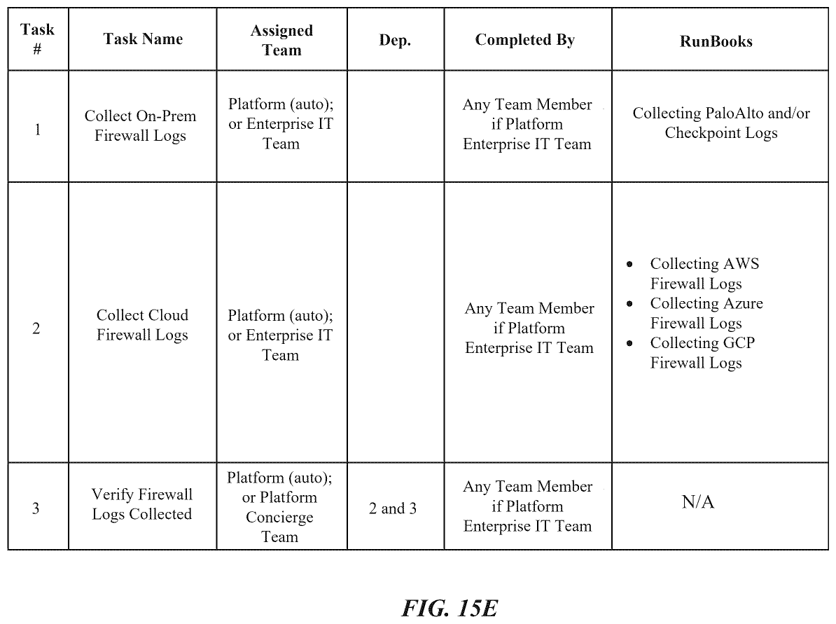

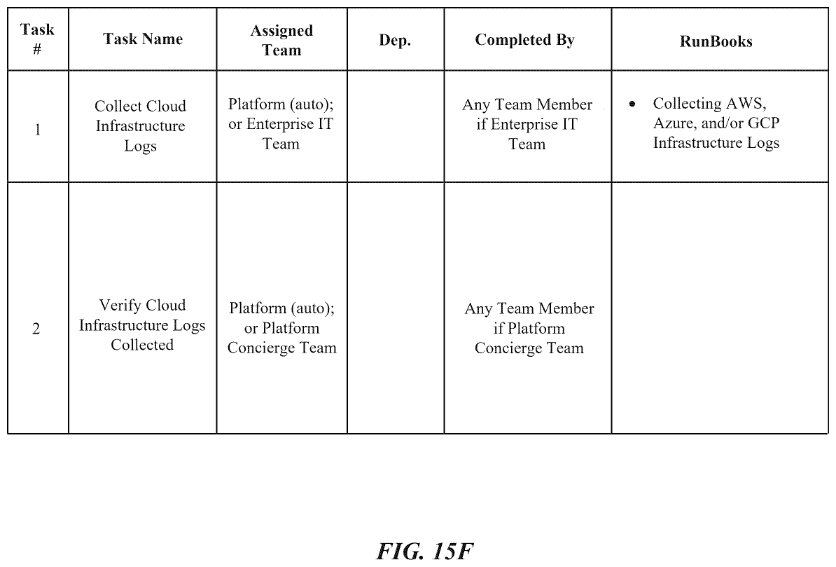

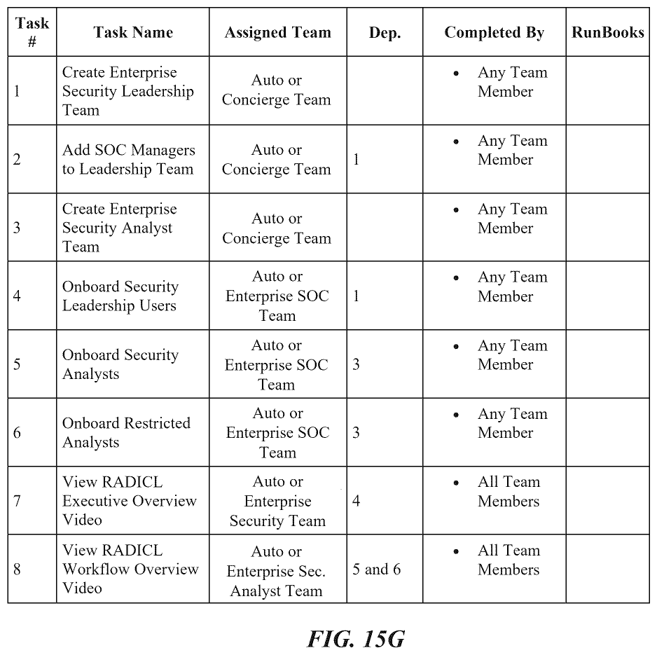

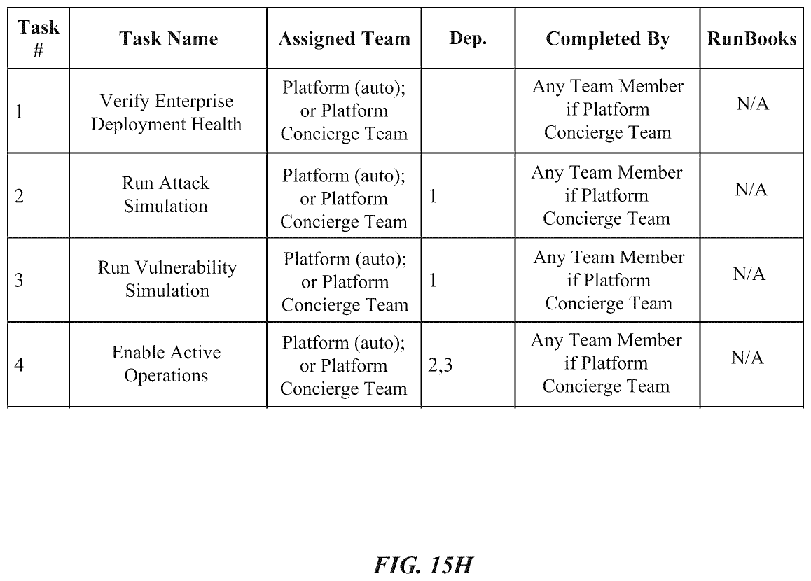

Task dependency module 108 may be configured to identify, for at least one task, one or more other tasks that are related to or dependent on the at least one task. FIGS. 15A through 15H provide additional details on task dependencies (e.g., a dependency of a first task within a task group (TG) to one or more other tasks in the TG) as well as TG dependencies (e.g., dependency of a first TG to one or more other TGs), in accordance with various aspects of the disclosure.

Library creation module 110 may be configured to create, using a computing platform, a plurality of libraries, where each of the plurality libraries comprises at least one work item template (WIT) associated with at least one work item type. In some cases, the term “work item template” or “WIT” may be used to refer to a collection (i.e., one or more) of pre-fabricated work items. Library creation module 110 may be further configured to assign at least one of the plurality of libraries to each of the plurality of tiers.

Work item template (WIT) module 109 may be configured to create, using the computing platform, a base WIT. In some implementations, the base WIT is associated with a plurality of properties or features. The WIT module 109 may be further configured to construct, using the computing platform, the at least one WIT for at least one of the plurality of libraries. In some implementations, constructing the at least one WIT for the at least one of the plurality of libraries comprises (1) extracting the plurality of properties/features from the base WIT, and (2) creating the at least one WIT, based on the extracting. In some aspects, the at least one WIT constructed by the computing platform may inherit the plurality of properties/features from the base WIT.

In some embodiments, the at least one WIT comprises a first WIT and a second WIT. In some embodiments, the first WIT may be associated with a first WI of the plurality of Wis, and the second WIT may be associated with a second WI of the plurality of Wis. In some embodiments, the first WI may comprise a first child WI and the second WI may comprise a second child WI. In some examples, the first WI is associated with a first work type and the second WI is associated with a second work type that is different from the first work type. Furthermore, the first child WI may be associated with the first work type, and the second child WI may be associated with a third work type that is different from each of the first and second work types.

In some implementations, the WIT module 109 may be configured to automatically create, using the computing platform, one or more WITs, where each WIT comprises data for creating at least one WI and where each WIT is selected from a group consisting of a task, an assessment, and a remediation.

In some examples, the one or more WITs comprises a first WIT and a second WIT. Furthermore, link identification module 112 may be configured to identify a link between the first WIT and the second WIT, where the link comprises one of a parent-child link, a dependency link, and a reference link. However, it should be noted that other types of links are also contemplated in different embodiments and examples listed herein are not intended to limit the scope and/or spirit of the present disclosure.

In some implementations, the WIT module 109 may be configured to work in conjunction with one or more of the library creation module 110, link identification module 112, and querying module 113.

The UI display module 111 is configured to display information related to one or more of work, work items, tasks, task groups, etc., pertaining to a case or a project (e.g., New Customer Onboarding Project), quantitative task metrics (e.g., status information for cases/projects assigned to a vSOC team, where the status information may include a breakdown showing the number of cases per stage, a chart or graph showing the number of cases per risk level), a table view listing the tasks within a TG including the team assigned to perform each task within the TG, and a query interface that enables a user to search for WITs, to name a few non-limiting examples. In some cases, the UI display module is configured to generate and display, on a computing device, at least the UI dashboards described below in relation to FIGS. 6, 7, 8, and/or 9. Furthermore, the UI dashboards can also be configured to display at least a portion of the information depicted in FIGS. 15A through 15H, either in the same or a different format. For example, the UI dashboard can be configured to display information related to the Team assigned to perform each of the different tasks in FIGS. 15A-H.

Link identification module 112 may be configured to identify, for at least one task, one or more tasks that are related to or dependent on the at least one task. In some implementations, the link identification module 112 may be configured to identify one or more links (e.g., a dependency link) between different TGs within a larger project (e.g., a New Customer Onboarding project), a link or relation between different WITs, or any other applicable links or relationships in a multi-tier and multi-tenant managed work architecture platform, such as system 100.

Querying module 113 may be configured to receive one or more queries from a computing device, for instance, via the UI displayed on the computing device. In some implementations, the queries may be related to a search request for a WIT, a search request for a specific project or case, and/or a search request for a library, to name a few non-limiting examples.

In some implementations, computing platform(s) 102, remote computing platform(s) 144, and/or external resources 130 may be operatively linked via one or more electronic communication links. For example, such electronic communication links may be established, at least in part, via a network 150 such as the Internet and/or other networks. It will be appreciated that this is not intended to be limiting, and that the scope of this disclosure includes implementations in which computing platform(s) 102, remote platform(s) 144, and/or external resources 130 may be operatively linked via some other communication media.

A given remote platform 144 may include one or more processors configured to execute computer program modules. The computer program modules may be configured to enable an expert or user associated with the given remote platform 144 to interface with system 100 and/or external resources 130, and/or provide other functionality attributed herein to remote platform(s) 104. By way of non-limiting example, a given remote platform 144 and/or a given computing platform 102 may include one or more of a server, a desktop computer, a laptop computer, a handheld computer, a tablet computing platform, a NetBook, a Smartphone, and/or any other applicable computing platform.

External resources 130 may include sources of information outside of system 100, external entities participating with system 100, and/or other resources. In some implementations, some or all of the functionality attributed herein to external resources 130 may be provided by resources included in system 100.

Computing platform(s) 102 may include electronic storage 132, one or more processors 134, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 132 may comprise non-transitory storage media that electronically stores information. The electronic storage media of electronic storage 132 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 132 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 132 may include one or more virtual storage resources (e.g., cloud storage, a virtual private network, and/or other virtual storage resources). Electronic storage 132 may store software algorithms, information determined by processor(s) 134, information received from computing platform(s) 102, information received from remote platform(s) 104, and/or other information that enables computing platform(s) 102 to function as described herein.

Processor(s) 134 may be configured to provide information processing capabilities in computing platform(s) 102. As such, processor(s) 134 may include one or more of a digital processor, an analog processor, a digital circuit designed to process information, an analog circuit designed to process information, a state machine, and/or other mechanisms for electronically processing information. Although processor(s) 134 is shown in FIG. 1 as a single entity, this is for illustrative purposes only. In some implementations, processor(s) 134 may include a plurality of processing units. These processing units may be physically located within the same device, or processor(s) 134 may represent processing functionality of a plurality of devices operating in coordination. Processor(s) 134 may be configured to execute modules 101, 102, 103, 104, 105, 106, 107, 108, 109, 110, 111, 112, 113, and/or other modules. Processor(s) 134 may be configured to execute modules 101, 102, 103, 104, 105, 106, 107, 108, 109, 110, 111, 112, 113, and/or other modules by software; hardware; firmware; some combination of software, hardware, and/or firmware; and/or other mechanisms for configuring processing capabilities on processor(s) 134. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 101, 102, 103, 104, 105, 106, 107, 108, 109, 110, 111, 112, and/or 113 are illustrated in FIG. 1 as being implemented within a single processing unit, in implementations in which processor(s) 134 includes multiple processing units, one or more of modules 101, 102, 103, 104, 105, 106, 107, 108, 109, 110, 11, 112, and/or 113 may be implemented remotely from the other modules. The description of the functionality provided by the different modules 101, 102, 103, 104, 105, 106, 107, 108, 109, 110, 111, 112, and/or 113 described below is for illustrative purposes, and is not intended to be limiting, as any of modules 101, 102, 103, 104, 105, 106, 107, 108, 109, 110, 111, 112, and/or 113 may provide more or less functionality than is described. For example, one or more of modules 101, 102, 103, 104, 105, 106, 107, 108, 109, 110, 111, 112, and/or 113 may be eliminated, and some or all of its functionality may be provided by other ones of modules 101, 102, 103, 104, 105, 106, 107, 108, 109, 110, 111, 112, and/or 113. As another example, processor(s) 134 may be configured to execute one or more additional modules that may perform some or all of the functionality attributed below to one of modules 101, 102, 103, 104, 105, 106, 107, 108, 109, 110, 111, 112, and/or 113.

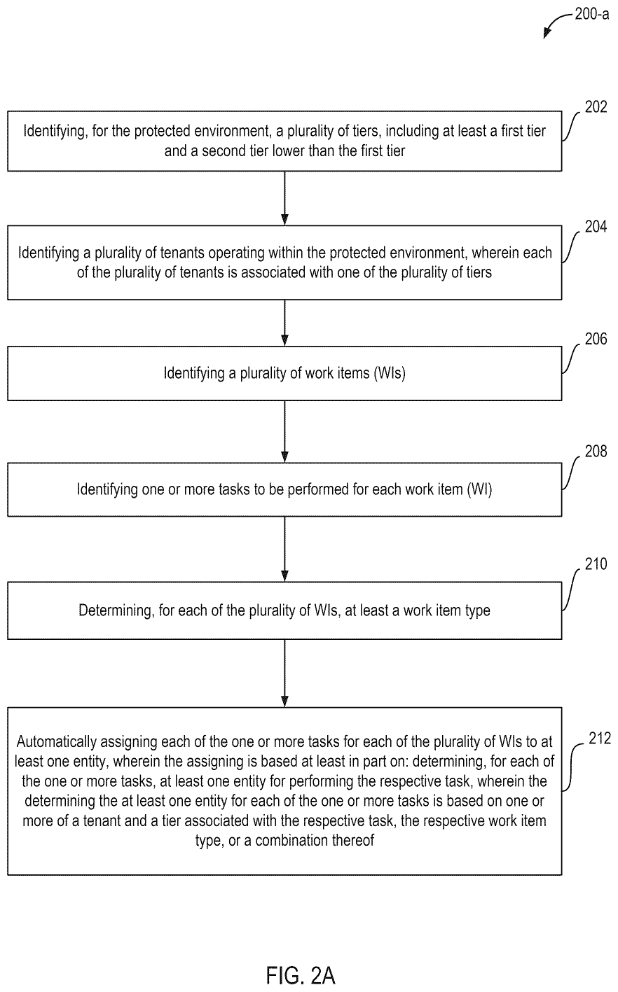

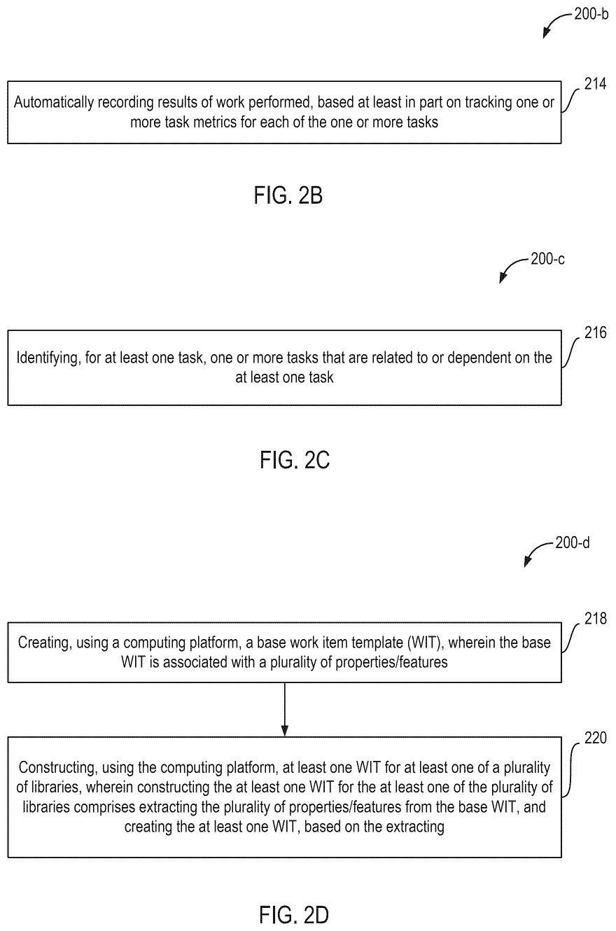

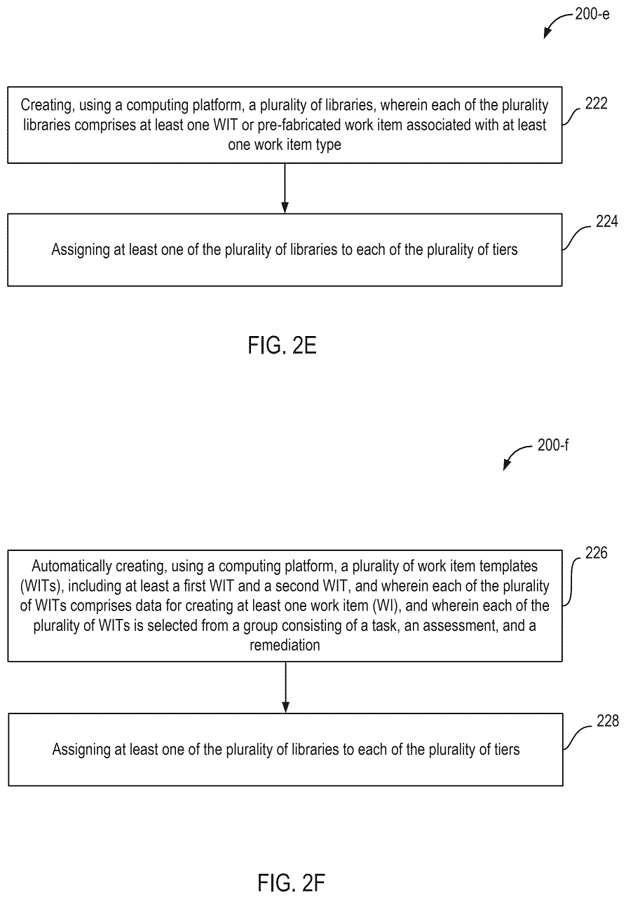

FIGS. 2A, 2B, 2C, 2D, 2E, and/or 2F illustrates method(s) 200 for creating and managing a multi-tenant and multi-tier managed work architecture using a computing platform (e.g., computing platform 102 in FIG. 1), in accordance with various aspects of the present disclosure. The operations of method(s) 200 presented below are intended to be illustrative. In some implementations, method(s) 200 may be accomplished with one or more additional operations not described, and/or without one or more of the operations discussed. Additionally, the order in which the operations of method(s) 200 are illustrated in FIGS. 2A, 2B, 2C, 2D, 2E, and/or 2F and described below is not intended to be limiting.

In some implementations, method(s) 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method(s) 200 in response to instructions stored electronically on an electronic storage medium. The one or more processing devices may include one or more devices configured through hardware, firmware, and/or software to be specifically designed for execution of one or more of the operations of method(s) 200.

FIG. 2A illustrates a first method 200-a for creating and managing a multi-tenant and multi-tier managed work architecture, in accordance with various aspects of the disclosure, in accordance with various aspects of the disclosure.

A first operation 202 may include identifying, for a protected environment, a plurality of tiers, including at least a first tier and a second tier lower than the first tier. First operation 202 may be performed by one or more hardware processors configured by machine-readable instructions including a module that is the same as or similar to tier identification module 101, in accordance with one or more implementations.

A second operation 204 may include identifying a plurality of tenants operating within the protected environment, where each of the plurality of tenants is associated with one of the plurality of tiers. Second operation 204 may be performed by one or more hardware processors configured by machine-readable instructions including a module that is the same as or similar to tenant identification module 102, in accordance with one or more implementations.

A third operation 206 may include identifying a plurality of work items (Wis). Third operation 206 may be performed by one or more hardware processors configured by machine-readable instructions including a module that is the same as or similar to work item identification module 103, in accordance with one or more implementations.

A fourth operation 208 may include identifying one or more tasks to be performed for each WI. Fourth operation 208 may be performed by one or more hardware processors configured by machine-readable instructions including a module that is the same as or similar to task identification module 104, in accordance with one or more implementations.

A fifth operation 210 may include determining, for each of the plurality of Wis, at least a work item type. Fifth operation 210 may be performed by one or more hardware processors configured by machine-readable instructions including a module that is the same as or similar to work item type identification module 105, in accordance with one or more implementations.

A sixth operation 212 may include automatically assigning each of the one or more tasks for each of the plurality of Wis to at least one entity, further described below in relation to FIGS. 15A through 15H. In some implementations, the assigning is based at least in part on determining, for each of the one or more tasks, at least one entity for performing the respective task, where the determining the at least one entity for each of the one or more tasks is based on one or more of a tenant and a tier associated with the respective task, the respective work item type, or a combination thereof. Sixth operation 212 may be performed by one or more hardware processors configured by machine-readable instructions including a module that is the same as or similar to work/task assigning module 106, in accordance with one or more implementations.

In some embodiments, an entity may comprise any one of a team (e.g., internal IT team associated with a client enterprise, security analyst team associated with the system or platform 100), a team member or user within a team, a user with a specific role or designation (e.g., user with admin privileges working in the human resources (HR) department at a client enterprise), a specific computing device (e.g., computing device with a specific IP address or MAC address), or any other applicable entity that is assigned and/or performs a work item, a task, etc. Other types of entities besides the ones described above are contemplated in different embodiments, and the examples listed herein are not intended to limit the scope and/or spirit of the present disclosure.

FIG. 2B illustrates method 200-b, in accordance with one or more implementations.

A first operation 214 may include automatically recording results of work performed, based at least in part on tracking one or more task metrics for each of the one or more tasks. First operation 216 may be performed by one or more hardware processors configured by machine-readable instructions including a module that is the same as or similar to one or more of task metrics module 107, in accordance with one or more implementations.

FIG. 2C illustrates method 200-c, in accordance with one or more implementations.

A first operation 220 may include identifying, for at least one task, one or more tasks that are related to or dependent on the at least one task. The first operation 216 may be performed by one or more hardware processors configured by machine-readable instructions including a module that is the same as or similar to task dependency module 108 in accordance with one or more implementations.

FIG. 2D illustrates method 200-d, in accordance with one or more implementations.

A first operation 218 may include creating, using a computing platform, a base WIT, where the base WIT is associated with a plurality of properties/features. First operation 218 may be performed by one or more hardware processors configured by machine-readable instructions including a module that is the same as or similar to one or more of WIT module 109 and library creation module 110, in accordance with one or more implementations.

A second operation 220 may include constructing, using the computing platform, at least one WIT for at least one of a plurality of libraries, where constructing the at least one WIT for the at least one of the plurality of libraries comprises extracting the plurality of properties/features from the base WIT, and creating the at least one WIT, based on the extracting. Second operation 220 may be performed by one or more hardware processors configured by machine-readable instructions including a module that is the same as or similar to one or more of WIT module 109 and library creation module 110, in accordance with one or more implementations.

FIG. 2E illustrates method 200-e, in accordance with one or more implementations.

A first operation 222 may include creating, using a computing platform, a plurality of libraries, where each of the plurality libraries comprises at least one WIT (or pre-fabricated work item) associated with at least one work item type. First operation 222 may be performed by one or more hardware processors configured by machine-readable instructions including a module that is the same as or similar to one or more of WIT module 109 and library creation module 110, in accordance with one or more implementations.

A second operation 224 may include assigning at least one of the plurality of libraries to each of the plurality of tiers. Second operation 222 may be performed by one or more hardware processors configured by machine-readable instructions including a module that is the same as or similar to one or more of work/task assigning module 106, WIT module 109, and library creation module 110, in accordance with one or more implementations.

FIG. 2F illustrates method 200-f, in accordance with one or more implementations.

A first operation 226 may include automatically creating, using a computing platform, a plurality of WITs, including at least a first WIT and a second WIT. In some implementations, each of the plurality of WITs comprises data for creating at least one work item (WI), where each of the plurality of WITs is selected from a group consisting of a task, an assessment, and a remediation. First operation 226 may be performed by one or more hardware processors configured by machine-readable instructions including a module that is the same as or similar to one or more of work item identification module 103, work item template module 109, and library creation module 110, in accordance with one or more implementations.

A second operation 228 may include assigning at least one of the plurality of libraries to each of the plurality of tiers. Second operation 228 may be performed by one or more hardware processors configured by machine-readable instructions including a module that is the same as or similar to one or more of work/task assigning module 106, WIT module 109, and library creation module 110, in accordance with one or more implementations.

FIG. 3 illustrates a block diagram of a system 300 configured for supporting a multiple-tenant and multiple-tier managed work architecture, according to various aspects of the disclosure. As seen, the system 300 shows customer infrastructure 301, a computing platform 302, a collaboration module 380, and protected customer(s) 390. In this example, the customer infrastructure 301 comprises or is associated with one or more of user(s) 306, first computing device(s) 305-a (e.g., a laptop, a desktop, a mobile computing device), second computing device(s) 305-b (e.g., a server), a network 308 (e.g., LAN, WLAN), a cloud network 309, and Internet of Things (IoT) device(s) 307. Additionally, the platform 302 comprises a virtual security operations center (vSOC) 360, an analytics module 350, a workflow module 370, and one or more optional modules (shown as optional by the dashed lines), such as, but not limited to, a threat hunt module 351, a threat respond module 352, a security harden module 353, a training module 354, and a compliance module 355. In some cases, the vSOC 360 comprises one or more optional modules (shown as optional by the dashed lines), such as, a threat investigation module 361 (e.g., associated with or used by a threat investigation team), an incident response module 362 (e.g., associated with or used by an incident response team), and a security intelligence module 363 (e.g., associated with or used by a security intelligence team).

In some embodiments, the workflow module 370 may be configured to identify and/or store information associated with one or more of cases 371 (e.g., an investigation into a possible compromise of a user's laptop and/or account), inquiries 372 (e.g., a question asked from one tenant to another tenant, in or across the same tier, where the inquiry may be a WI and each question may be a sub-WI, for instance, “Is this employee currently working in China?”), assessments 373 (e.g., an assessment related to the state of something, typically in a compliance context, for instance, determine if an acceptable use policy exists and meets certain minimum set of criteria), tasks 374, exercises 375 (e.g., Wis that may be used to test a user's comprehension or response to something, for instance, a simulated phishing email containing a link may be sent to multiple users with the intention that the users should not click on that link, and data related to the users that did click on the simulated phishing link maybe measured/collected, reported, and/or aggregated across one or more tenants), and remediations 376. Furthermore, the workflow module 370 may be configured to exchange information with the collaboration module 380, shown by dataflow 317-c. As shown, the collaboration module 380 may be configured to directly exchange the protected customer(s) 390, for instance, via dataflow 317-d, where the dataflow 317-d may include questions or inquiries regarding the tenant, notifications, follow-up questions or inquiries, comments added to Wis, notes, or entities contained in Wis (e.g., notes, an attached machine entity). In some cases, the collaboration module 380 may also be configured to relay information to the workflow module 370 via dataflow 317-c (e.g., responses to tasks, responses to inquiries, comments on Wis or notes/entities contained in the Wis).

In this example, the analytics module 350 of the platform 302 is configured to receive and/or extract information from the customer infrastructure 301 using dataflow 317-a (e.g., threat visibility related information, alarms, logs, events) and dataflow 317-b (e.g., vulnerability visibility related information, vulnerabilities, weaknesses). In some cases, the analytics module 350 may be configured to create and/or manage an entity-oriented data fabric (EODF), in accordance with one or more implementations.

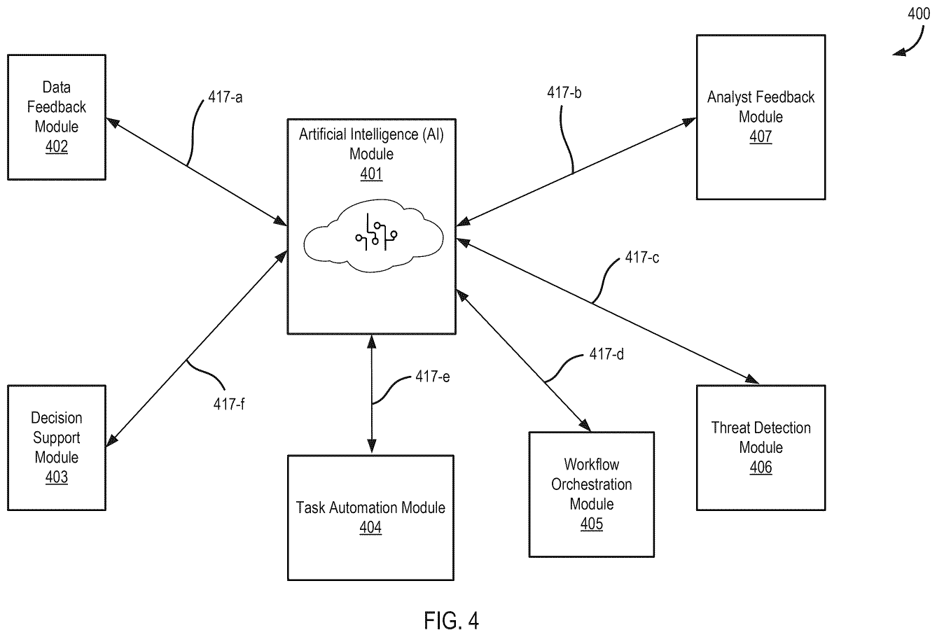

In some embodiments, the system 300 is configured to employ artificial intelligence (Al) for one or more workflow automation and threat detection, in accordance with various aspects of the disclosure. In some aspects, the application of AI in the platform 302 may assist in one or more of enhancing the accuracy of decisions, automating actions, and/or detecting advanced threats (e.g., threats associated with a nation-state adversary with significant resources and computing power at their disposal). Furthermore, over time and across one or more tenants, the vSOC 360 may construct new work items (e.g., ad-hoc work items) and leverage existing Wis from one or more libraries (e.g., shown as Library 1202 in FIG. 12). The construction and leveraging of work items by vSOC 360, within work areas, and in real-world “live-fire” situations may be automatically recorded by the platform 302 and utilized by the AI module (e.g., AI module 401 in FIG. 4) to build new workflow models and/or reinforce (i.e., update) existing workflow models, which can help augment and automate workflows compared to prior art systems.

In some embodiments, each of the protected customer(s) 390 may be associated with one or more computing devices, such as, but not limited to, a mobile computing device (e.g., smartphone, a table computer), a laptop, a desktop, a NetBook, a server, or any other applicable computing device. In some cases, the protected customer(s) 390 may comprise one or more of an executive or C-suite team member 391 (e.g., a CEO, a CTO, a COO, a CFO, etc.), an IT team member 392, an HR team member 393, a legal team member 394, an external consultant 395, and any other employee 396 of an organization or enterprise.

In some embodiments, the platform 302 is configured to deploy a cybersecurity agent 333 on the customer infrastructure 301, where the cybersecurity agent 333 may be a third-party cybersecurity agent, such as, CrowdStrike Falcon. However, it should be noted that CrowdStrike is just one non-limiting example of a cybersecurity agent that may be deployed on the customer infrastructure 301 and any other applicable cybersecurity agent known or contemplated in the art may be employed in different embodiments. In some instances, the cybersecurity agent 333 may be a cloud native and/or AI powered cybersecurity agent that is configured to assist in one or more of stopping cybersecurity breaches, ransomware, malware, hacking, and/or another applicable cyber-attack. In some embodiments, the cybersecurity agent 333 may be configured to collect any type of data relevant to any type of workflows. Furthermore, the cybersecurity agent 333 may also be configured to initiate any type of action on the deployed system and within the environment the agent/system lives, such as the customer infrastructure 301.

FIG. 4 illustrates a block diagram showing various modules of a platform 400, according to various aspects of the disclosure. In some embodiments, the platform 400 may be similar or substantially similar to the computing platform 102 described in relation to FIG. 1 and/or the platform 302 described in relation to FIG. 3.

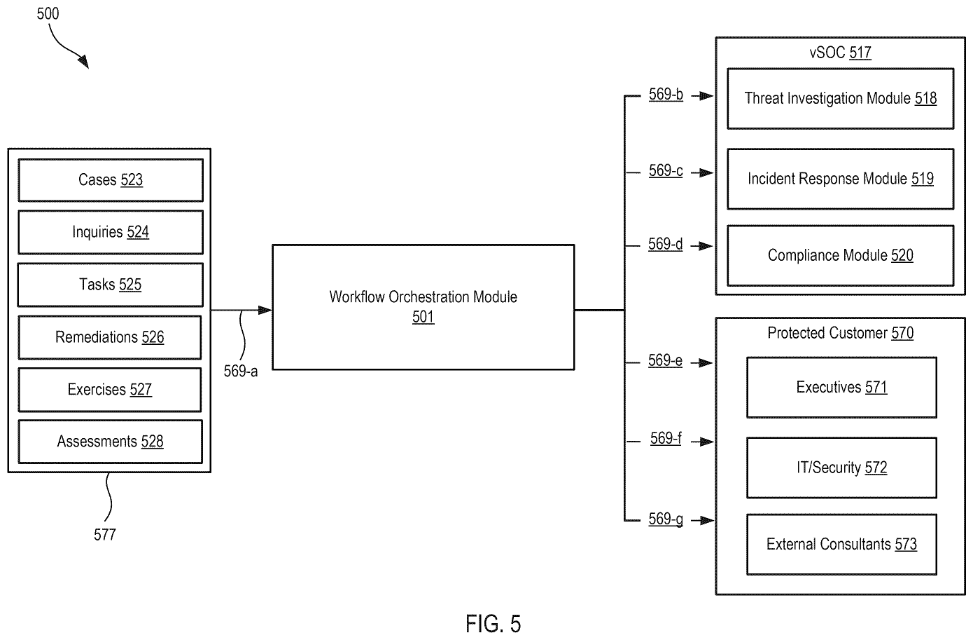

In some embodiments, the workflow orchestration module 405 may be similar or substantially similar to any of the workflow orchestration modules described herein, including at least the workflow orchestration module 501 described below in reference to FIG. 5. Additionally, or alternatively, the workflow orchestration module 405 may implement one or more aspects of any of the tier identification module 101, tenant identification module 102, work item identification module 103, task identification module 104, work item type identification module 105, work/task assigning module 106, task dependency module 108, WIT module 109, library creation module 110, UI display module 111, link identification module 112, and/or querying module 113 described above in reference to FIG. 1. It should be noted that the AI module 401, analyst feedback module 407, threat detection module 406, workflow orchestration module 405, task automation module 404, decision support module 403, and data feedback module 402 may be embodied in hardware, software, or a combination thereof.

As seen in FIG. 4, the platform 400 may comprise an AI module 401, an analyst feedback module 407, a threat detection module 406, a workflow orchestration module 405, a task automation module 404, a decision support module 403, and a data feedback module 402. As described in further detail below, the AI module 401 may be configured to communicate with one or more of the: data feedback module 402 using first dataflow 417-a, analyst feedback module 407 using second dataflow 417-b, threat detection module 406 using third dataflow 417-c, workflow orchestration module 405 using fourth dataflow 417-d, task automation module 404 using fifth dataflow 417-e, and/or decision support module 403 using sixth dataflow 417-f.

In some examples, dataflow 417-a may be used for analyzing prior workflows (e.g., across tenants), which can assist in predicting appropriate workflows in future scenarios.

In some examples, dataflow 417-b may allow an analyst to select or reject workflows proposed by the AI module 401, which can assist the AI module 401 with its learning process and allow the AI to learn from the analyst feedback.

Dataflow 417-c may allow the AI module 401 to detect threatening, anomalous, and/or malicious activity in the protected environment through observing data within a specific tenant and/or observing patterns across all (or a majority of) tenants.

In some cases, the AI module 401 may be configured to construct a complex sequence of tasks, that can be performed across one or more tiers. In such cases, the AI module 401 and the workflow orchestration module 405 may exchange relevant information using dataflow 417-d, which allows the AI module 401 to construct the one or more sequences of tasks (e.g., manual tasks, automated tasks).

In some cases, information exchanged between the AI module 401 and the task automation module 404 using dataflow 417-e may include machine executable code synthesized by the AI module 401, parameters for passing into existing code for the automatic execution of one or more tasks, to name two non-limiting examples.

In some cases, the AI module 401 is configured to present, via dataflow 417-f, information to a user based on observations of past actions and/or decisions across a plurality of tenants, which may help guide current actions of a contextually similar scenario.

As noted above, in some embodiments, the computing platform, such as platform 400, of the present disclosure is configured to employ AI for one or more of workflow automation and threat detection. In some aspects, the application of AI in the platform 400 may assist in one or more of enhancing the accuracy of decisions, automating actions, and/or detecting advanced threats (e.g., threats associated with a nation-state adversary with significant resources and computing power at their disposal). As noted above, over time and across one or more tenants, the vSOC team associated with the platform 400 may construct new work items (e.g., ad-hoc work items) and leverage existing Wis from one or more libraries (e.g., shown as Library 1202 in FIG. 12). The construction and leveraging of work items by the vSOC team, within work areas, and in real-world “live-fire” situations may be automatically recorded by the platform 400 and utilized to build new workflow models and/or reinforce (i.e., update) existing workflow models, which can help augment and automate workflows compared to prior art systems. In addition to the above, across tenants, the AI module 401 of the platform 400 may be configured to suggest or automatically construct work items for execution for one or more other tenants, based on previously constructed and executed work items for similar tenants, tenants in similar scenarios, or both. Such a design can assist in proactively reducing cyber incident risk, as compared to prior art systems.

In some embodiments, the system or platform is configured to support case or project management to help ensure that threat indicators and/or incidents are tracked to completion. Furthermore, the platform can also be configured to help ensure that workflows are designed to optimize analyst speed and/or accuracy, by the application of AI-augmented automation. In some instances, the system or platform is configured to track any relevant activity and evidence, which enables a higher level of transparency and more effective collaboration between analysts (e.g., associated with the platform) and protected clients/customers.

In some embodiments, the AI module 401 is configured to predict the appropriate work item(s) that should be performed or executed (e.g., manually by a user, automatically by a computing platform, such as platform 100 or 300) based on identifying one or more work items that were previously executed in similar scenarios. In some cases, the one or more work items identified by the AI module 401 may be selected from a library, such as library 1202 in FIG. 12. In some other cases, the AI module 401 may be configured to automatically construct a customized or ad-hoc work item, where constructing the customized or ad-hoc work item may be based in part on identifying one or more work items that were previously executed in similar scenarios. In some cases, the customized or ad-hoc work item may implement one or more aspects of such previously performed work items (or tasks). The AI module 401 may be configured to utilize information related to one or more entities associated with the previously performed work items in constructing said ad-hoc work items. Additionally, or alternatively, the AI module 401 may also utilize information related to the tenant, where the information related to the tenant may be automatically gathered by the system based on monitoring/observing the tenant's IT infrastructure. In some cases, a cybersecurity agent (e.g., cybersecurity agent 333 in FIG. 3) may be configured to relay information related to the tenant or customer's IT infrastructure to the platform 400. With regards to work item construction, in some embodiments, the AI module 401 may be configured to leverage and pull in content from available models that contain “AI advise” and synthesize this advice with other information, such as, but not limited to, tenant-specific information and/or scenario-specific information that is uniquely known to the model(s).

Within a tenant work area scenario, the system may be configured to leverage bespoke or 3P AI models, extract relevant entities (e.g., user device information, user information, user account information, user credentials, to name a few) from a work item, and construct executable code (i.e., stored in a non-transitory computer readable storage medium) to automatically perform said work item. Within a Tenant Work Area scenario, the system 400 or AI module 401 may be configured to determine whether a particular work item should be assigned to and/or performed by a user or should be automatically executed with minimal to no human intervention. As an example, certain tasks (e.g., task 3 in FIG. 15A related to watching a video, task 4 in FIG. 15A related to passing a quiz) may need to be performed by a human operator, as further described below with reference to FIGS. 15A through 15H. Furthermore, certain tasks (e.g., installing a software patch in response to detecting a vulnerability) may either be performed manually by a human operator, or automatically by the computing platform or system 400 of the present disclosure. In some instances, the AI module 401 may be configured to consider for the work item to be performed, one or more of a severity or risk level, time sensitivity, estimated duration of work item, and/or any other relevant factors while determining whether the work item should be assigned to a human operator or the computing system/platform. For example, the AI module 401 may be configured to assign a work item that is intended to address a vulnerability having a “high risk” level to the computing system/platform 400. In another example, the AI module 401 may assign a work item that is intended to address a vulnerability having a “minor” or “none” risk level to a human user. In yet another example, the AI module 401 may assign a work item that is estimated to take a significant duration of time (e.g., >2 hours, >4 hours, >1 hour, etc.) to the computing system/platform. In yet another example, the AI module 401 may assign a work item, such as installing a software patch on a plurality of computing devices/machines, to the computing platform/system based on determining the estimated time and/or effort needed to complete the work item exceeds a pre-defined threshold (e.g., >30 minutes, >1 hour).

In some embodiments, the AI module 401 may also be configured to assess one or more of prior decisions (e.g., received from decision support module 403 via dataflow 417-f), user feedback information (e.g., received from data feedback module 402 via dataflow 417-a, received from analyst feedback module 407 via dataflow 417-b), prior decision approvals (e.g., received from decision support module 403 via dataflow 417-f), and/or any recorded negative outcomes (e.g., received from data feedback module 402 and/or analyst feedback module 407) for similar or substantially similar work items in order to determine an appropriate entity (e.g., a user, a Team, Team Members of the Team, a user device or machine associated with the user, an IT administrator, the disclosed system or platform, etc.) for performing a particular task or work item. In some embodiments, the system or platform may also be configured to infuse, into the decision, relevant risk indicators that influence the urgency of action, as such risk indicators may necessitate/prioritize automated execution.

In some embodiments, one or more work management tiers (or simply, tiers) can be defined in the platform, such as platform(s) 102,300,400, and/or 500. In some embodiments, each tier may be associated with one or more unique work types. In some embodiments, each tier (e.g., work management tier) may be associated with one or more libraries, where each of the one or more libraries may comprise at least one pre-fabricated work item (also referred to as a work item template or WIT). Furthermore, each of the one or more pre-fabricated work items (or WITs) may be associated with a work item type (or simply, work type). In some examples, the platform or system of the present disclosure may utilize an inheritance model, which allows the creation of one or more work item objects from another work item object (e.g., a “base” work item object). In some cases, a first work item object, such as a base work item object, may be associated with or defined using a plurality of properties or features. Furthermore, a second work item object may be created using the first work item object, where creating the second work item object may be based in part on the second work item object inheriting the plurality of properties/features from the first or base work item object. In some cases, the second work item object may be associated with the same or a different work type as the first work item object. Said another way, a base work item object can be utilized to construct a plurality of different work item objects, where each of the plurality of work item objects constructed from the base work item object may be of the same or a different work type as compared to the base work item object.

In some cases, work items or Wis may be assigned a distinct work type, where the work type may be manually assigned (e.g., by a system or IT administrator) or automatically assigned (e.g., using a module, such as the AI module 401, of the platform). In some embodiments, a work item (or WI) may comprise one or more “child” work items. As an example, if a first work item comprises a task, the child work item of the first work item may comprise a sub-task of the task. Furthermore, in some embodiments, a child work item may itself comprise or be associated with one or more other “child” work items. In some examples, a child work item of another work item (herein referred to as a parent work item) may be associated with the same or a different work type as the parent work item.

In some embodiments, the platform enables a user to define one or more tenant tiers, such as, but not limited to, a Platform tier, a vSOC tier, and an Enterprise/Organization tier. However, it should be noted that the number of tenant tiers is not intended to be limiting and more or less than three (3) tiers can be defined in different embodiments. In some cases, each of the one or more tenant tiers may be associated with or contain one or more teams, where each team is authorized to execute a certain work type from the plurality of work types. For instance, the vSOC tier may be associated with a vSOC team (e.g., vSOC 360 in FIG. 3). Some non-limiting examples of teams may include a Compliance Team (e.g., Compliance 355), a Threat Investigation team (e.g., Threat Investigation 361), and an Incident Response team (e.g., Incident Response 362), although other types of teams are also contemplated in different embodiments.

Some non-limiting examples of procedures and tasks may include one or more of working cases, onboarding/managing enterprises (e.g., creating teams, adding users, adding data sources, etc.), optimizing operations (e.g., creating a task, creating a WIT, creating new template tasks, to name a few non-limiting examples), creating and/or updating content (e.g., creating a task to tweak or update a correlation rule setting). In some aspects, tasks may also be utilized to encapsulate work that could or should be automatically performed by the system or platform. Furthermore, tasks can be defined to measure and/or record (e.g., in a quantitative manner) the results of work, where the work may be manually performed (e.g., by a user, an IT administrator) or automatically performed (e.g., by the computing platform).

In some cases, a task may be manually created (e.g., by a user). In some other cases, a task can be initiated from a library of pre-packaged automated tasks. In some examples, a task can be a part of a larger collection of related tasks. Furthermore, a task can have dependencies on other tasks and/or be a dependency to other tasks. Additional details on tasks, task groups, and task dependencies are further described below in relation to at least FIG. 12 and FIGS. 15A through 15H.

In some embodiments, tasks may encapsulate their related items or entities, where the related items/entities may be leveraged to inform and drive workflow (e.g., automated workflow). In some cases, tasks may contain entities, where the entities may contain or may be associated with one or more properties/features. Furthermore, the properties/features of the entity contained in a task may be used to help drive the workflow. As an example, a workflow may comprise disabling a user account. In this case, the user account to be disabled may be attached or included within the task or work item as an Account Entity and the username of the specific account may be included as a property/feature of the Account Entity instance.

In some examples, items/entities may also serve as the input and output data element(s) passed between playbooks and automated tasks. In some instances, “Playbook” is the term that is more often used by businesses, where a Playbook is used to encapsulate manual and automated work. Similarly, the term “Runbook” is the term more often used by IT teams, where a Runbook encapsulates standard procedures in support of a specific task. As used herein, the terms “Playbook” and “Runbook” may be used interchangeably throughout the disclosure since both terms are used to generally define a standard set of work items or tasks that need to be performed for a given situation, such as, an incident.

In some embodiments, the system (e.g., system 100,300,400, and/or 500) of the present disclosure is configured to automatically assign work (e.g., work items, tasks, and/or task groups) to appropriate teams. In some cases, this automated assignment of tasks may be based in part on identifying a work type. Some non-limiting examples of work types may include Triage,

Investigate, User Management, Device Management, Content Management, and Training Orchestration. In some examples, tasks within a task group (TG) may be associated with or assigned the same work type. Furthermore, a team (e.g., Compliance Team) may be configured and authorized to execute a pre-defined work type. In some instances, each work type (e.g., Triage or Investigate) may be assigned a default team that is authorized/assigned to perform the work associated with said work type. Furthermore, each task may be assigned a tenant tier that is responsible for and/or authorized to perform the work associated with the corresponding task. As noted above, the tenant tier may be selected from a group consisting of a Platform tier, a vSOC tier, and an Enterprise tier.

As used herein, the term “Task Group” may be used to refer to a collection of tasks. In some cases, a task group may be associated with a work item type and a team. Furthermore, the various tasks within a task group may or may not be associated with the same work item type and/or team as the task group.

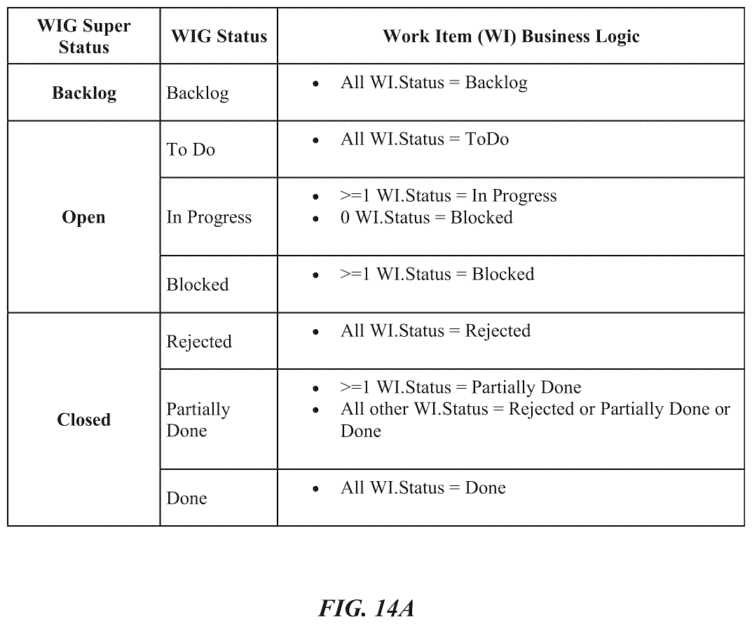

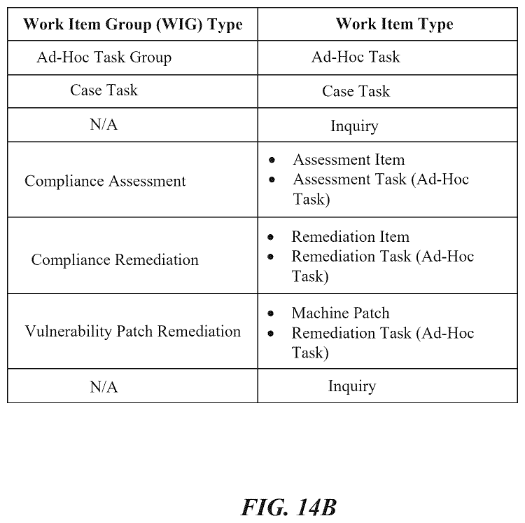

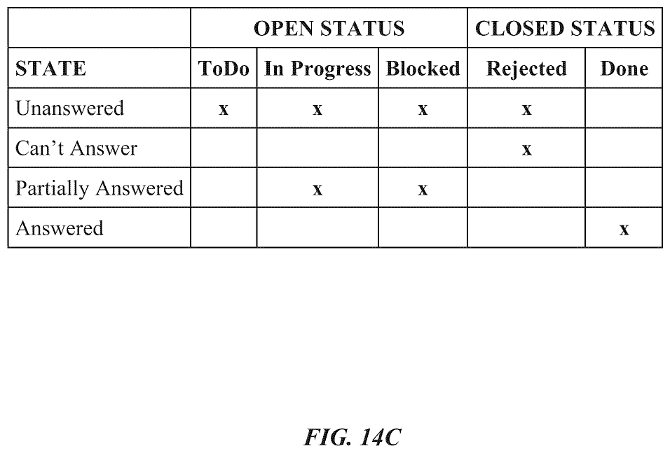

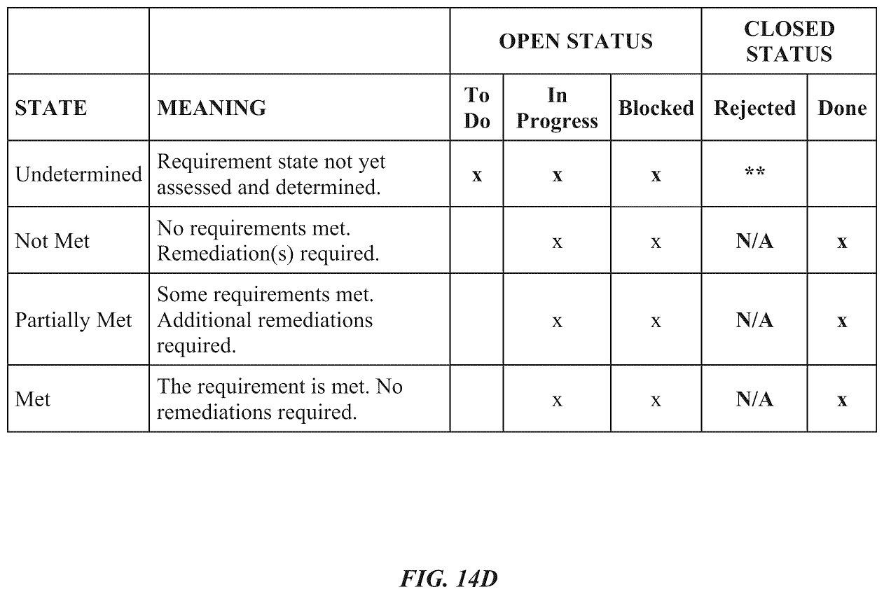

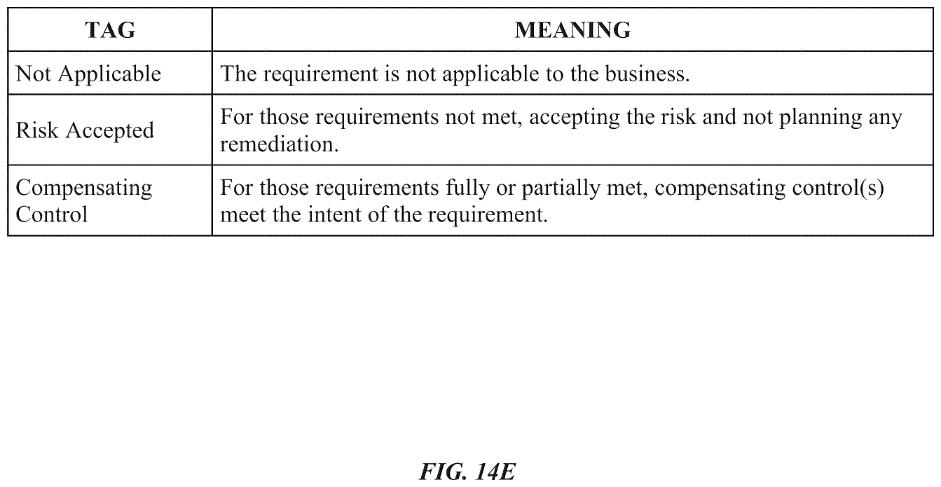

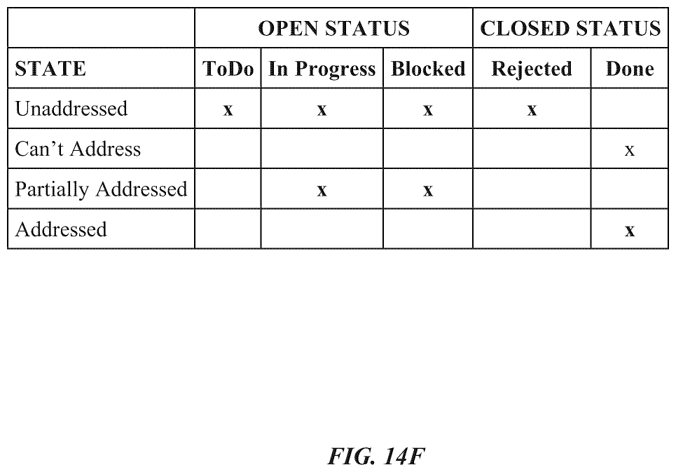

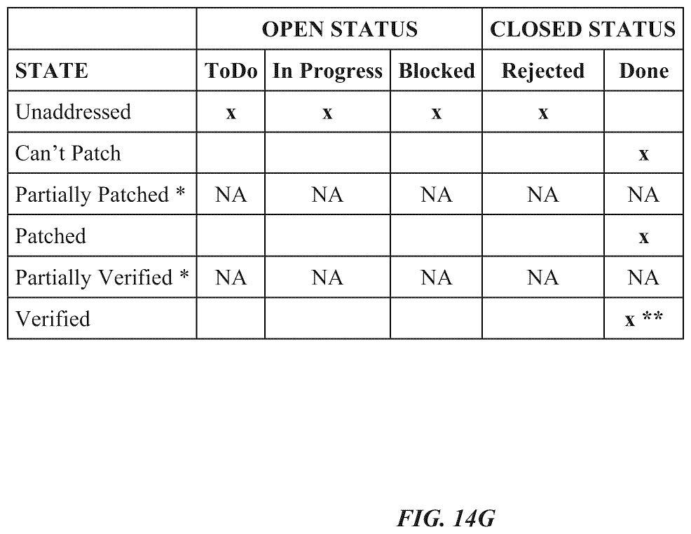

As used herein, the term “Work Item Group” or “WIG” may be used to refer to a container of related work items. In accordance with aspects of the present disclosure, WIGs may be used to organize a related set of work, communicate a status for a body of work, and/or communicate an outcome state for the body of work. The system or platform may allow a user to define one or more properties/features for a WIG, where the properties/features associated with the WIG may comprise one or more of a Summary, Common Guidance (optional), Private or Team, and Dependencies. In some instances, the Common Guidance property/feature may allow a user to specify a guidance at the WIG level, that would apply to all work items contained within the WIG. Furthermore, the Private/Team property may be used to indicate whether the work items contained within the WIG should be private or team based. Lastly, the Dependencies property may be used to specify dependencies (if any) of the WIG to one or more other WIGs. Additional details on work item types, tasks, TGs, and/or WIGs are provided in FIGS. 14A through 14G, as well as FIGS. 15A through 15H.

In some cases, the system (e.g., system 100,300,400, and/or 500) of the present disclosure is configured to automatically specify (or allow a user to specify) one or more of a tenant tier and a work type when a new task or task group is created. In such cases, the system is configured to utilize the information related to the tenant tier and work type for the newly created task or task group to automatically assign the default team from the specified tenant tier.

As used herein, the term “Perpetual Project” may refer to a project that exists for a longer duration than an “Ephemeral project”. Furthermore, perpetual projects may be characterized as such since additional work may be added to such projects at regular or substantially regular intervals. In some aspects, “Case Management” may be an example of a perpetual project, however other types of perpetual projects are also contemplated in different embodiments. In some cases, perpetual projects may include one or more of user onboarding, data onboarding, security awareness training, compliance management, and/or vulnerability management. In contrast, an ephemeral project may refer to a project that has a concrete or pre-defined “done” state. In other words, an ephemeral project can be assigned a “Closed” or “Completed” status and hidden within the system when the ephemeral project comprises a “done” state. As an example, an ephemeral project may comprise removing a malware or ransomware program from a user's computing device. In such cases, upon removal of the malware or ransomware program from the user's computing device, the ephemeral project may comprise a Closed or Completed status and hidden within the system. In some examples, a project may be associated with a plurality of properties/features, such as, but not limited to, an Owner, Task(s), Initiation Date, Target Completion Date, Datetime Started, Datetime Completed, and/or Age.

In some embodiments, the system of the present disclosure supports the use of Work Item Libraries (e.g., shown as Library 1202 in FIG. 12), described in further detail below. In some cases, Work Item Libraries may enable the creation of Work Item Templates (WITs), where a WIT may be used to store prepackaged content that can be further used to create work items of various types. Some non-limiting examples of WIT types include Tasks (e.g., shown as Task 1215 in FIG. 12), Task Groups (e.g., shown as TG 1214 in FIG. 12), Assessments, Assessment Tasks, Assessment Remediations, and/or Vulnerability Remediations. In some embodiments, the system is configured to manage one or more WITs in a library (i.e., Work Item Library). Furthermore, libraries can be managed and compartmentalized at each platform tier. In some cases, at the Platform Tier, the system allows the WITs to be available to Platform, vSOC, and Enterprise tenants. Furthermore, at the vSOC Tier, the system allows the WITs to be available to vSOC and Enterprise tenants. Lastly, at the Enterprise Tier, the system may only allow the WITs specific to that Enterprise to be made available.

In some embodiments, WITs within a library can be organized such that they have one or more of (1) a parent WIT, and (2) a dependency on another WIT. In some cases, each of the WITs within a library may have a dependency on the same or a different WIT. In some cases, the system enables a user to create a work item via a WIT. In such cases, the querying module or the system 100 may allow the user to search for relevant WITs and select the WIT to use for creating the work item. In such cases, the system is configured to create the work item based on extracting the properties/features from the parent WIT (if any) of the selected WIT, extracting the properties/features from child WITs (if any) of the selected WIT, and/or extracting information related to the dependencies of the selected WIT. In some instances, the UI display module or the system is configured to display the properties/features associated with the selected WIT, including the properties/features from its parent WIT, child WITs, and/or dependencies on the UI of the user's computing device. Additionally, the system may allow the user to edit the pre-packaged content (e.g., extracted properties or features) via the UI displayed on the computing device. Furthermore, the user may also populate any additional fields, if needed, via the UI on the computing device. The system may automatically save the work item to a data store of the system/computing platform.

In some embodiments of the present disclosure, WITs may be structured as “Items”. Additionally, the system may be configured to leverage Item Links to represent dependencies or relationships between WITs. As an example, the compliance module 355 in FIG. 3 may comprise Assessment WITs that assess the state of something (e.g., if configuration settings comply with a pre-defined standard). Furthermore, the platform 302 in FIG. 3 may also comprise Remediation WITs that fix the state of something (e.g., fix the configuration settings if they do not comply with the pre-defined standard). In such cases, there may exist a relationship or link between the Assessment WITs (sub-tasks) and the Remediation WITs. Furthermore, if the requirement assessment comes back as “UNMET”, the relationship/link between the Assessment and Remediation WITs may allow the platform 302 to automatically tee up the appropriate related Remediation that should be executed to “meet” the requirement and pass a future assessment.

In some cases, WITs may be stored in libraries, where the libraries can utilize Open Search for persistence. In some examples, the system may support the use of a query language (e.g., EASS), which enables an end-user to search for WITs stored in the data store of the system/platform. In some aspects, the use of a query language or search feature allows a user to quickly search for WITs, which facilitates in enhancing efficiency and operational scaling, as compared to the prior art. Furthermore, the use of Items (i.e., for structuring WITs) helps provide a flexible structure for storing different types of content. In some cases, the system allows Item/Entity UI elements to be cross-leveraged and create more general-purpose UL In some aspects, WITs themselves can be Items or Entities. Specifically, but without limitations, WITs can also be structured as Entities for the purpose of creating links between and further enriching the WITs, which allows them to enjoy the same benefits of the entity-oriented data fabric (EODF).

As noted above, in some cases, each WIT may be associated with a work item type (or simply, work type). In some cases, WITs of certain types may have specific properties/features that may need to be populated or defined, e.g., by a user, automatically determined by the system. Furthermore, WITs of certain types may have unique back-end processing logic, in accordance with one or more implementations of the disclosure. As an example, WITs of type “Vulnerability Remediation” may be automatically evaluated by the system, e.g., using back-end processing logic, and used to automatically create Vulnerability Remediation tasks for one or more Enterprises. WITs may comprise a plurality of properties/features that may be common across WITs regardless of work type. Some non-limiting examples of such standard properties/features associated with WITs may comprise: Summary, Work Tier, Work Type, and Duration. In some cases, additional properties/features may be defined based on the type of WIT. For instance, for a WIT of the type “Task”, an additional property (e.g., Detail) may be utilized. Additionally, for a WIT of the type “Assessment”, additional properties (e.g., Guidance, Compliance Items) may be utilized. Similarly, for a WIT of the type “Vulnerability Remediation”, an additional property, such as Guidance, may be utilized.

In some cases, relationships or links may be utilized to identify WIT dependencies. As an example, a link called “Blocks” may be utilized to link two (2) WITs, for instance, WIT 1 Blocks WIT 2. In another example, two different links called “Blocks” and “Blocked By” may be utilized. As an example, a first WIT 1 “Blocks” a second WIT 2 and the second WIT 2 is “Blocked By” the first WIT 1. In some embodiments, the system is configured to display information related to the links/relationships of one or more WITs via the UI on the computing device. For instance, if a user finds the first WIT 1 using the search feature, the system is configured to display the relationship or link (e.g., Blocks) between the first and the second WITs. As an example, an Incident Response Playbook may comprise a series of steps to perform, where each subsequent step is dependent on the other. For instance, the series of steps, which may need to be performed in the order listed below, in the Incident Response Playbook may include (1) Physically disconnect ethemet cable, (2) Login as Admin, (3) Install memory capture software, (4) Run a particular script, (5) Save output file to an empty USB drive or other storage media, and (6) Extract USB drive and use a network connected system to upload the output file stored on the USB drive to secure cloud storage.

The system of the present disclosure may also support access control for WITs, which prevents unauthorized access to WITs. For instance, an access scope for each WIT may be defined (e.g., user defined, or automatically defined by the AI module 401 of the system), where the access scope identifies the tenant tiers (e.g., Platform tier, vSOC tier, Enterprise tier) that can view and use a particular WIT. In accordance with various aspects of the disclosure, the system/platform may also support change control, which facilitates in providing standard, consistent, and high-quality workflows, as compared to the prior art. In some cases, the system/platform may only allow certain authorized users (e.g., based on role privileges) to create draft WITs. Additionally, or alternatively, the system or platform may only allow certain authorized users to promote or convert a “draft” WIT to a “Final” or “Complete” WIT. Furthermore, the system or platform may also store a copy of all prior versions of a WIT, which allows a certain authorized user to roll back a WIT to a prior version of said WIT. In some instances, each WIT may comprise an “Is Published” property, which can be used to indicate whether a WIT has been published and ready for use (e.g., to create tasks). In some instances, WITs may comprise an editing stage, where the editing stage is used to indicate whether work is being performed on a WIT. For instance, an editing stage for a WIT may comprise one of a New Draft (i.e., WIT is being developed for the first time), Updated Draft (i.e., an existing and published WIT is being updated), Review (i.e., a new draft WIT is being updated or reviewed before it is published), and Complete (i.e., WIT is ready and editing is complete). In some cases, when a new WIT is marked as Complete, the system or platform is configured to automatically set the value of the “Is Published” property to “True”.

Turning now to FIG. 5, which illustrates another block diagram 500 of a computing platform or system configured for supporting a multiple-tenant and multiple-tier managed work architecture, according to various aspects of the disclosure. As seen, the computing platform or system (500) comprises a workflow orchestration module 501 that is electrically, logically, and/or communicatively coupled to a plurality of modules, including a work module 577, a vSOC module 517, and a protected customer module 570. The workflow orchestration module 501 is configured to receive information related to one or more of cases 523, inquiries 524, tasks 525, remediations 526, exercises 527, and assessments 528 from the work module 577 via dataflow 569-a. Furthermore, the workflow orchestration module 501 is configured to communicate with various modules of the vSOC 517 and the protected customer 570 via dataflows 569-b through 569-g.

For instance, the workflow orchestration module 501 may be configured to provide information related to one or more of a threat actor (i.e., malicious or attacker entity, such as a hacker), a threat actor IT infrastructure, a threat (e.g., software vulnerability, ransomware program, malware program), and/or another applicable threat (e.g., a scan of the dark web revealed that an enterprise user's credentials were found, sold, or made available for sale on the dark web) to threat investigation module 518 via dataflow 569-b.

Furthermore, the workflow orchestration module 501 may be configured to provide information related to one or more of security incidents, work item(s) to be performed in response to detecting a security incident, work item(s) to be performed for a vulnerability remediation, information related to one or more entities (e.g., a working entity that is assigned or performs the work item, may be a team or a specific team member; WI encompassed entity that is included/contained/referenced within the work item, may be a user account, user credentials information, weakness or vulnerability) relevant to the work items to be performed, and/or any other applicable information relevant to a security incident or a vulnerability remediation to incident response module 519 via dataflow 569-c.

In some cases, work items may be associated with specific work types (i.e., types of work areas). For instance, work items may be associated with Security Incident cases, Vulnerability Remediations, and Compliance Assessments, to name three non-limiting examples. For example, a Security Incident may have a work item that instructs a user on how to run an interrogation script on an impacted computing device (or machine). In another example, a Security Incident may have a work item that involves the system 500 automatically running the interrogation script on the impacted computing device/machine. As another example, a Vulnerability Remediation may have a work item that instructs a user on how to install software security patches on a plurality of computing devices/machines that have been impacted (e.g., by a software bug, a software vulnerability). Alternatively, a Vulnerability Remediation may have a work item that involves the system 500 automatically installing the necessary patches on the plurality of impacted computing devices/machines, where the automatic installing of the software patches may be based in part on the system 500 programmatically interfacing with the computing device(s) directly, or programmatically interfacing with another system (not shown) that is electrically, logically, and/or communicatively coupled to the impacted computing device(s).

In some embodiments, the workflow orchestration module 501 may be configured to provide information related to one or more work items associated with a Compliance Assessment to compliance module 520 via dataflow 569-d. In some cases, a Compliance Assessment may have a work item that (1) instructs a user on how to evaluate configuration settings with an information system (e.g., a cloud infrastructure, an on-premises server) and evaluate whether it complies with a pre-defined standard, or (2) involves the system 500 programmatically interfacing with the information system to automatically query the configuration setting(s) of the information system and determine whether the configuration setting(s) adequately meet the pre-defined standard.

In some embodiments, work items contain (or may be associated with) entities that are relevant to the work to be performed. For instance, a work item related to a Security Incident may include one or more of the following entities (1) computing devices/machines suspected of being compromised, (2) user accounts suspected of being compromised, (3) vulnerability associated with a compromise, and/or (4) threat actor associated with a compromise.

In another example, a work item related to a Vulnerability Remediation may include one or more of the following entities (1) computing devices or machines associated with the Vulnerability Remediation, and/or (2) a vulnerability associated with the Vulnerability Remediation.

In yet another example, a work item related to a Compliance Assessment may include one or more of the following entities (1) a cloud service associated with the Compliance Assessment, where the cloud service may include one or more of a name of the cloud service, information pertaining to the cloud service's infrastructure, geographic location(s) where data is stored by the cloud service provider, any known vulnerabilities or security incidents that are currently impacting or have previously impacted the cloud service, and resiliency of the cloud service to external attacks or threats, to name a few non-limiting examples.

In some cases, the protected customer 570 may compnse an Enterprise, where the protected customer 570 may include one or more of executives 571, IT or security 572, and external consultants 573. Furthermore, the workflow orchestration module 501 may be configured to communicate relevant information to the computing devices associated with one or more of the executives 571, IT/security 572, and external consultants 573 of an Enterprise via dataflows 569-e, 569-f, and 569-g, respectively.

For instance, the workflow orchestration module 501 may be configured to relay information related to one or more work item(s) that may need to be manually performed by the protected customer 570. As an example, the workflow orchestration module 501 may be configured to send instruction(s) on how to run an interrogation script, install a software security patch, etc., to the protected customer 570. Alternatively, the workflow orchestration module 501 may transmit an instruction to perform a password update, software update, activate multi-factor authentication (MFA), setup a hardware authentication device (e.g., YubiKey), setup biometrics authentication, etc., to the protected customer. In yet another example, the workflow orchestration 501 may include information that enables IT/Security 572 to obtain the configuration settings of an information system, such as an on-premises server, and provide the information to the vSOC 517, which enables the vSOC 517 to determine whether the configuration settings are standard-compliant.

FIG. 6 illustrates an example of a UI dashboard 600 that can be displayed on a computing device, according to various aspects of the present disclosure. In this example, the UI dashboard 600 displays information related to a workbench for a user of the system or platform. As seen in FIG. 6, the UI dashboard displays a histogram or bar graph 666 of the number of cases 606 against time (i.e., date 626), where the number of cases 606 is shown along the vertical or y-axis and the date 626 is shown along the horizontal or x-axis. The UI dashboard 600 also shows a summary of the assigned cases (656), where the summary of the assigned cases (656) includes a case ID (e.g., Case #40, Case #38, etc.), a name of the Enterprise associated with each case (e.g., Enterprise A, Enterprise B, etc.), a case name (e.g., Operation Barrel Roll, Project Bravo, etc.) for each case, a risk level (e.g., out of 10) for each case, an age (e.g., 1 day, 3 days, 4 days, etc.), a status of each case (e.g., Triage-Pending, Recovery-IP, Triage-Blocked), a state of each case (e.g., Open or Closed), and the team (e.g., Triage Team, Recovery Team) assigned to each case.

In some embodiments, the UI dashboard 600 may also enable the user to create a new case (shown by the clickable button 681 on the top-right of the UI dashboard 600) and access information related to tasks 650. In this example, the tasks display (650) shown on the bottom right of the UI dashboard 600 includes a plurality of hyperlinks or clickable buttons that allow the user to navigate to task-specific pages for each of tasks 651-a, 651-b, 651-c, and 651-d.

In some embodiments, the UI dashboard 600 may be configured to present quantitative information related to the Cases to the end-user using one or more of graphs (e.g., 2-D or 3D bar graphs), charts (e.g., pie charts, donut charts), tables, scatter plots, and/or any other applicable visualizations. In other words, the use of a bar graph and a donut chart, as shown in FIG. 6, is not intended to limit the scope and/or spirit of the present disclosure. In this example, the quantitative information displayed to the user may enable the user to easily understand how the number of cases per stage (e.g., Recovery Stage 607, Mitigate Stage 617, Investigate Stage 627, and Triage Stage 637) vary over time, as shown in the bar graph 666 on the top-left of the page. Furthermore, the UI dashboard 600 also enables the user to quickly and easily understand what proportion of Open Cases are in each of the Recovery Stage 607, Mitigate Stage 617, Investigate Stage 627, and Triage Stage 637, via the donut chart 696 near the top-right of the page.

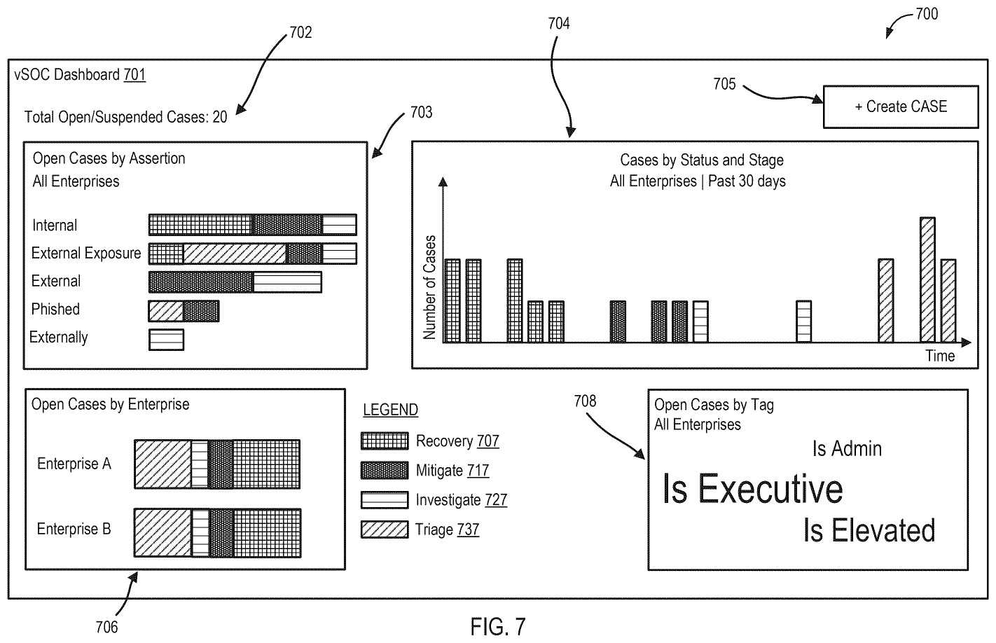

FIG. 7 illustrates another example of a UI dashboard 700, according to various aspects of the present disclosure. The UI dashboard 700 may implement one or more aspects of the UI dashboard 600 described above in relation to FIG. 6. In this example, the UI dashboard 700 is an example of a vSOC dashboard 701 that can be displayed to a vSOC user or team member of the disclosed system.

In this example, the UI dashboard 700 displays a total number of Open/Suspended cases (e.g., 20 Open/Suspended cases) via display item 702, a clickable button 705 for creating a new case, a graph 703 of the number of Open Cases by Assertion across all Enterprises, a graph 704 of the Number of Cases by Status and Stage for all Enterprises in the past 30 days, a graph 706 showing the number of Open Cases by Enterprise, and a display item 708 showing the number of Open Cases by Tag, where the relative font size of the tags (e.g., Is Admin, Is Executive, Is Elevated) indicates the relative prevalence of each tag amongst the Open Cases. For instance, in this example, a larger number of Open Cases are associated with the tag (Is Executive) as compared to the tag (Is Admin), due to the larger font size of “Is Executive” in display item 708.

Similar to FIG. 6, it should be noted that, more or less information than shown in UI dashboard 700 may be displayed to an end-user (e.g., vSOC user or team member) in different embodiments. Furthermore, other types of visualizations (e.g., vertical bar graph instead of a horizontal bar graph in display item 703, a pie chart or donut chart instead of a vertical bar graph in display graph 704, etc.) may be utilized in different embodiments without departing from the scope and/or spirit of the present disclosure. In this example, UI dashboard 700 also displays a legend for the various graphs and/or charts, where the legend includes a different type of shading for each of the different stages (e.g., Recovery Stage 707, Mitigate Stage 717, Investigate Stage 727, and Triage Stage 737).

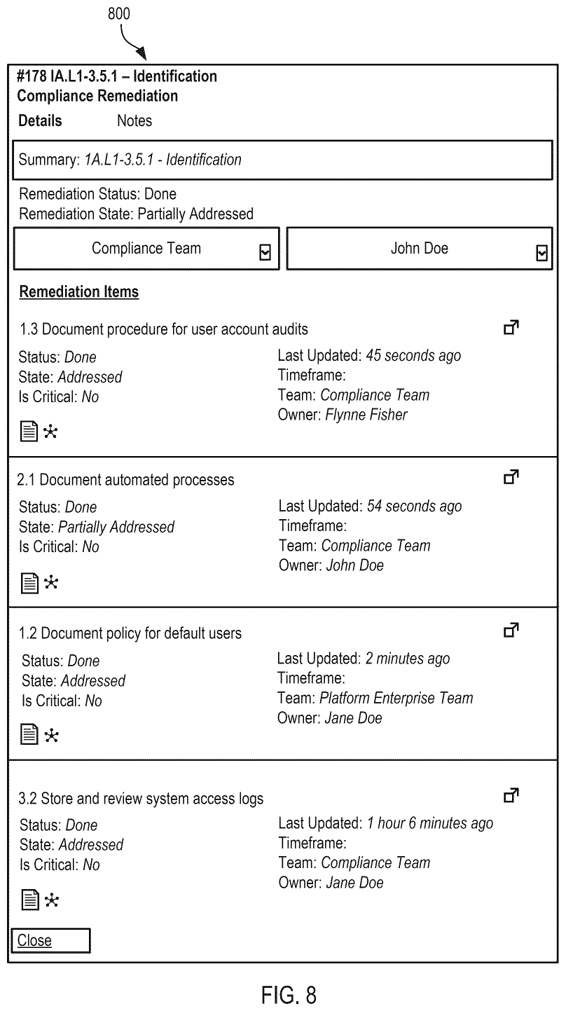

FIG. 8 illustrates a UI 800 pertaining to a Compliance Remediation Pane that may be displayed by the system on a user's computing device, according to various aspects of the disclosure.

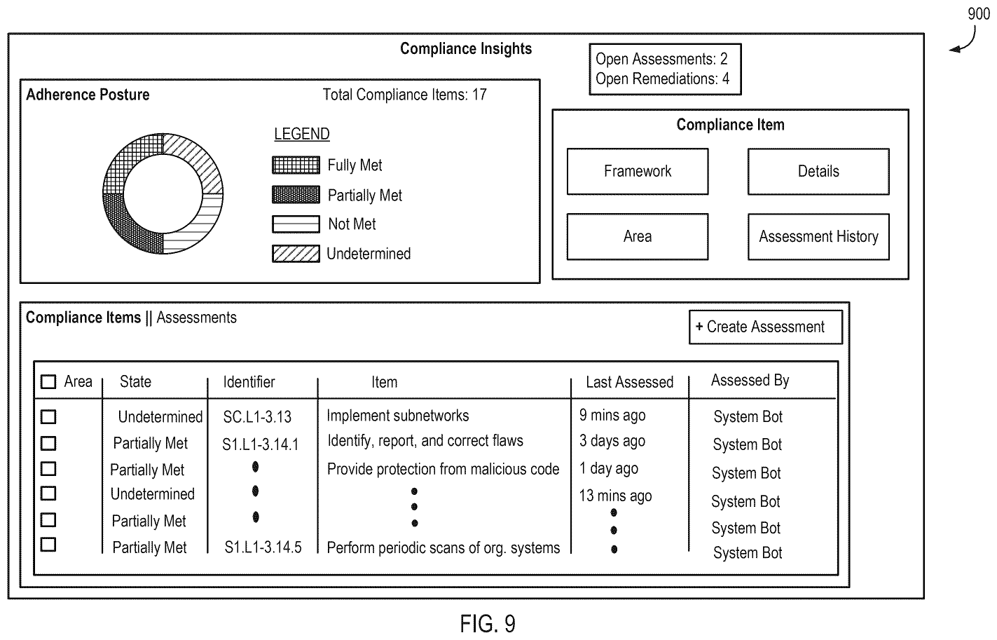

FIG. 9 illustrates a UI 900 showing Compliance Insights that may be displayed by the system on a user's computing device, according to various aspects of the disclosure.

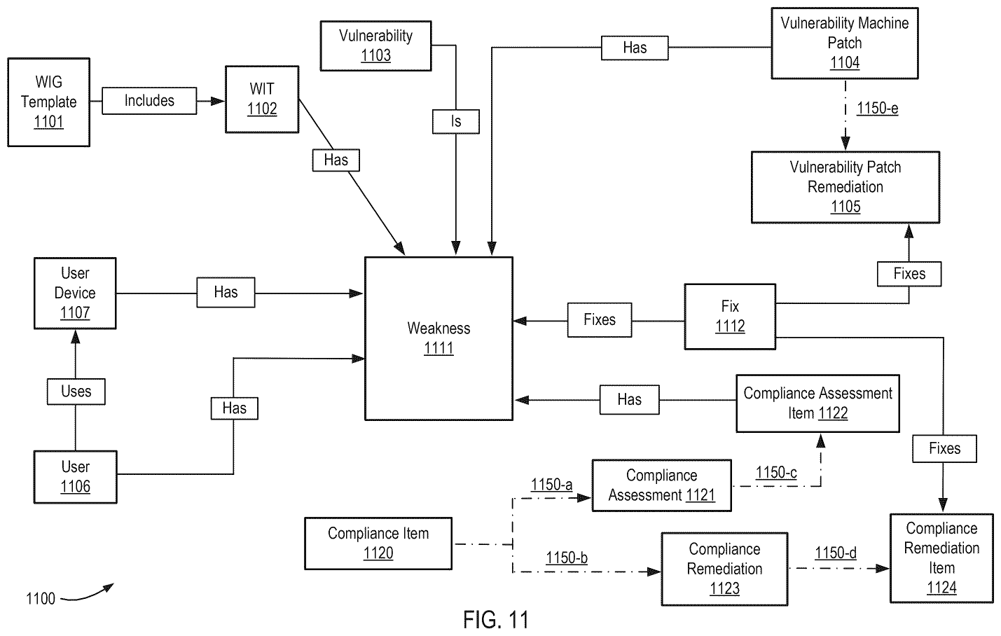

FIG. 11 illustrates an example of a process flow 1100 in a multiple-tenant and multiple-tier managed work architecture, according to various aspects of the disclosure.

In this example, the system (e.g., system 100,300, and/or 500) has detected a vulnerability 1103, where the vulnerability is a weakness 1111. In some cases, the weakness 1111 may be an example of a known weakness (i.e., weakness is known and/or has been previously identified by the system). Additionally, the weakness 1111 may be associated with a weakness type, such as, but not limited to, a software vulnerability, a misconfiguration, a policy gap (e.g., customer lacks an acceptable use policy), a process gap (e.g., customer or client does not have a pre-defined process for offboarding a terminated employee), an awareness gap, or a malware initiation. For sake of illustration, FIG. 11 only depicts a single weakness 1111, however, it should be noted that the system may be configured to detect a plurality of other weaknesses, as further described below.

As seen, FIG. 11 also shows a user 1106, where the user 1106 uses a user device 1107. In some examples, the user 1106 and user device 1107 may be examples of entities. Here, each of the user 1106 and the user device 1107 have a weakness 1111, where the weakness associated with the user 1106 may be of the same or a different weakness type than the weakness type associated with the user device 1107 and/or the vulnerability 1103. Similarly, FIG. 11 also shows a work item group (WIG) template 1101, where the WIG template 1101 includes a work item template (WIT) 1102. In some circumstances, a WIT 1102 may point to a certain weakness 1111, as shown in FIG. 11. In such cases, the WIT 1102 may serve to drive remediation of the weakness 1111.

In some embodiments, the system is configured to determine one or more fixes 1112, as shown in FIG. 11. For instance, the system may identify at least one fix 1112 for fixing the weakness 1111. Some non-limiting examples of fix types may include a software patch, malware removal, reconfiguration (i.e., of misconfigured settings), policy improvement (e.g., implementing an acceptable use policy based on identifying that the customer lacks an acceptable use policy), process improvement (e.g., implementing or suggesting a process for offboarding employees, based on identifying that the customer or client does not have a pre-defined process for offboarding a terminated employee), and/or awareness training. For example, as shown in FIG. 11, a vulnerability machine patch 1104 (e.g., an initial version of a software patch) may have a weakness 1111. Furthermore, as shown by arrow 1150-e, the vulnerability machine patch 1104 may be associated with a vulnerability patch remediation 1105. In such cases, the fix 1112 identified by the system may be employed to fix the vulnerability patch remediation 1105, in accordance with one or more implementations.

Similarly, FIG. 11 also shows a compliance item 1120, where the compliance item 1120 is associated with or comprises a compliance assessment 1121 and a compliance remediation 1123, as shown by arrows 1150-a and 1150-b, respectively. The compliance assessment 1121 may be associated with (shown by arrow 1150-c) a compliance assessment item 1122, where the compliance assessment item 1122 has a weakness 1111. Additionally, the compliance remediation 1123 is associated with (shown by arrow 1150-d) a compliance remediation item 1124. In some embodiments, at least one of the fixes 1112 identified by the system may be utilized to fix the compliance remediation item 1124.

FIG. 12 illustrates an object relationship diagram 1200 showing a plurality of task management objects, according to various aspects of the disclosure. In some aspects, the plurality of task management objects (e.g., task object 1215, work type object 1207, task group (TG) object 1214, etc.) are some non-limiting examples of objects that may be supported by the computing platform or system (e.g., system 100) of the present disclosure. It should be noted that other types of task management objects in addition to the ones illustrated in FIG. 12 are contemplated in different embodiments, and the task management objects discussed herein are not intended to limit the scope and/or spirit of the present disclosure.

The system, such as system 100, of the present disclosure is configured to create and utilize different types of task management objects. As shown in FIG. 12, some non-limiting examples of task management objects may include a task object 1215, a task type object 1208, a work type object 1207, a TG object 1214, a project object (e.g., task project object 1204, template project object 1203), a RunBook object 1210, a PlayBook object 1209, a case object 1206, and a library object 1202. It should be noted that one or more of the task management objects (e.g., case object 1206, RunBook object 1210) depicted in FIG. 12 may be optional. Here, bi-directional arrows 1269 depict some examples of the possible links/relationships between the various objects and the various entities (e.g., Entity of Interest (EOI) 1211, Team 1205). However, for sake of illustration and clarity, not all the bi-directional arrows have been labeled in FIG. 12. It should be noted in some examples one or more of the arrows 1269 may be unidirectional instead of bi-directional.

In some examples, the task object 1215 may comprise an object associated with a discrete, measured unit of work that may be performed by a user or the system. In some cases, the task object 1215 can be associated with a plurality of properties or features, such as, but not limited to, a summary, details on how to complete the task, due date, and a tenant tier (e.g., Platform tier task, vSOC tier task, Enterprise tier task, Null), a work type (optional if tenant tier=Null), assigned team (optional if tenant tier=Null), assigned user (optional if tenant tier=Null), case ID (optional), case stage (optional), note (e.g., a note field that can be used for capturing ad-hoc notes and/or thoughts of person working on the task), status (e.g., New, In Progress, Blocked, Rejected, Complete), status log, and/or other audit fields (e.g., created by, created on, updated by, updated on, etc.). Some additional properties that may be associated with task objects, such as task object 1215, may include: Status Audit, Task Type, Attachments, Secrets, Dependencies, Comments, Estimated Duration, Actual/Calculated Duration, and/or Template Task. In some instances, a Template Task property/feature may comprise a link to the template that the task was created from. For example, in FIG. task 1215 and template task 1212 are linked by an arrow 1269. In some aspects, by linking back to the template 1212, the system allows task instances (i.e., task object 1215) to be automatically updated if the template (i.e., template task 1212) changes. Additionally, or alternatively, a link to the template 1212 also allows for automatic calculation of the average time needed to complete a task 1215, based in part on the average time/duration needed to complete other tasks derived from or associated with the template 1212.

In some examples, the task type object 1208 may comprise an object that is used to define a specific type of task (e.g., task 1215). In some cases, types of tasks may have unique properties and/or workflow characteristics. Some non-limiting examples of task types (i.e., defined via task type object 1208) may comprise: Personal To Do tasks, Team To Do tasks, Auto Task, Binary Inquiry, Choice Inquiry, and/or a Response Inquiry.

In some examples, the work type object 1207 may comprise an object that is used to define the specific type of work to be performed. In some cases, work types may be used to align tasks (e.g., task 1215) to teams (e.g., team 1205). In some cases, a Platform work type (e.g., maybe defined using work type object 1207) may comprise one or more of: threat detection content, workflow content, security awareness training content, and data onboarding content. In some cases, a vSOC work type (e.g., maybe defined using work type object 1207) may comprise one or more of: threat detection content, workflow content, security awareness training content, data onboarding content, threat investigation, incident response, and enterprise resiliency. Furthermore, an Enterprise work type (e.g., maybe defined using work type object 1207) may comprise one or more of: threat investigation, incident response, HR inquiries, legal inquiries, system administration, network administration, and user administration. In some cases, a work type object, such as work type object 1207, may be associated with at least a Name property and a Description property.

In some examples, the TG object 1214 may comprise an object that can be used to define a collection of related tasks and/or task groups, where the tasks and/or task groups serve to accomplish a larger objective. In some cases, the TG object 1214 may be associated with a plurality of properties/features, some non-limiting examples of which include a Name, a Work Type, an Assigned Team, a Status (e.g., Open or Closed), a Datetime Started (e.g., derived from earliest Task start date), a Datetime Completed (e.g., derived from latest Task complete date), Age, and/or Dependencies.

In some examples, the RunBook object 1210 may comprise an object that can be used to define a specific set of instructions or procedures for manually accomplishing discrete tasks.

In some examples, the PlayBook object 1209 may comprise an object that can be used to define a programmatically orchestrated collection of tasks, where the task execution may be automated.

In some examples, the library object 1202 may comprise an object that can be utilized to provide a space (i.e., storage space) for tenants, such as tenant 1201, to save master copies of configuration related data for the purpose of driving operational consistency and/or for sharing with one or more other tenants. In some cases, the library object 1202 may comprise a collection of saved tasks (e.g., template task 1212, task 1215), task groups (e.g., template TG 1213, TG 1214), and/or projects (e.g., template project 1203, task project 1204) that can be maintained as master templates, shared with others (i.e., users, tenants, teams, etc.), and/or cloned to drive consistent operational execution.

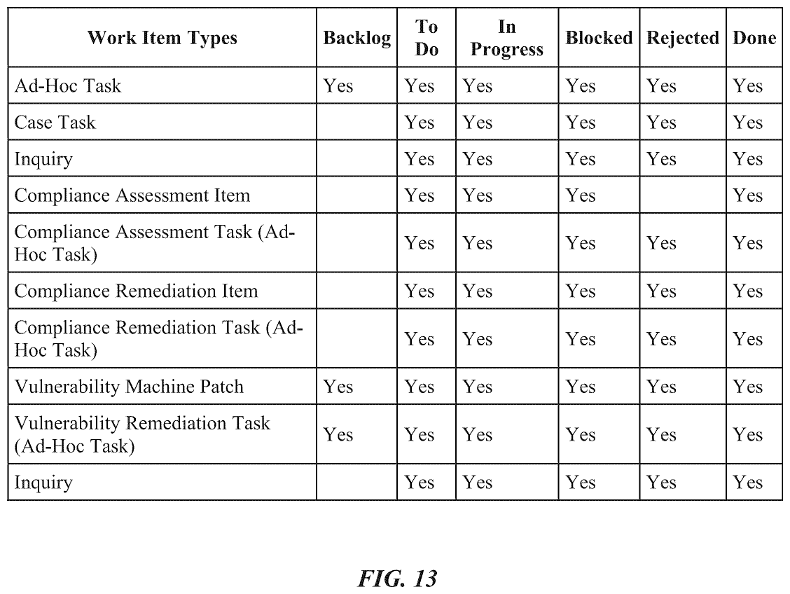

FIG. 13 illustrates examples of different work item types as well as standard and allowed work item status values (e.g., Backlog, To Do, In Progress, Blocked, Rejected, Done) for each work item type.

FIG. 14A is directed to the relation between different work item group (WIG) super statuses, WIG statuses, and WI business logics, in accordance with various aspects of the disclosure. In some aspects, Table 2A depicts the standard status values a WIG can have, which may be derived from the underlying work items associated with the WIG

FIG. 14B illustrates examples of various WIG types and WI types, in accordance with various aspects of the disclosure.

FIGS. 14C, 14D, 14E, 14F, and 14G illustrate various relationships between different states and WIG statuses, according to various aspects of the present disclosure.

FIG. 14C illustrates examples of allowed state/status value combinations for Inquiry Tasks.

FIG. 14D illustrates examples of allowed state/status value combinations for Compliance Assessment Wis. In Table 2D, “**” indicates that this is valid when rejecting at the parent level. In some examples, Compliance Assessment items cannot be individually rejected.

FIG. 14E illustrates examples of Compliance Assessment Item Qualifier Tags.

FIG. 14F illustrates examples of allowed state/status value combinations for Compliance Remediation Wis.

FIG. 14G illustrates examples of allowed state/status value combinations for Vulnerability Patch Remediation Wis. In Table 2G, “*” indicates that the partially patched and partially verified states can only be used for the Vulnerability Patch Remediation (WIG), i.e., not allowed for the Task. Furthermore, in Table 2G, “**” indicates that the Close Status when the State=Verified can only be set automatically by the system/platform.

FIGS. 15A, 15B, 15C, 15D, 15E, 15F, 15G, and 15H are each directed to a different task group (TG) of a larger New Customer Onboarding Project and present information related to the various tasks within each TG, according to various aspects of the present disclosure.

One non-limiting example of a project may comprise New Customer Onboarding, where the project may comprise a collection of task groups (e.g., shown as TG 1214 in FIG. 12) to help ensure that all clients/customers are onboarded in a consistent manner to the platform/system of the present disclosure, as further described below in relation to FIGS. 15A through 15H. In some examples, a New Customer Onboarding project may not have any dependencies to other projects. As shown, each of FIGS. 15A through 15H comprise a plurality of rows (one for each task) and a plurality of columns (e.g., a first column listing the task number, a second column listing the task name, a third column listing the assigned team(s), a fourth column listing the task dependencies (if any), a fifth column listing the name of entity that completed the task, and a sixth column listing the RunBooks, if any (also shown as RunBook 1210 in FIG. 12)).

In this example, the project (e.g., also shown as template project 1203 and/or task project 1204 in FIG. 12) may comprise a first task group (FIG. 15A), where the first task group may be assigned to a first team (e.g., Onboard Enterprise SOC Team). Additionally, the project may comprise a second task group (FIG. 15B), where the second task group may be assigned to a second team (e.g., Onboard Enterprise IT Team). The project may also comprise a third task group (e.g., deploy Collectors, shown in FIG. 15C), a fourth task group (e.g., Onboard CrowdStrike Falcon (CSP) Endpoint Detection and Response (EDR), shown in FIG. 15D), a fifth task group (e.g., Onboard Firewall Logs, shown in FIG. 15E), a sixth task group (e.g., Onboard Cloud Infrastructure Logs, shown in FIG. 15F), a seventh task group (e.g., Onboard Executives and Citizen Analysts, shown in FIG. 15G), and an eighth task group (e.g., Initiate Operations, shown in FIG. 15H).

The first task group (i.e., FIG. 15A) may comprise a plurality of tasks, including a first task (e.g., Create Enterprise SOC Team), a second task (e.g., Add Enterprise SOC managers to SOC Team), a third task (e.g., watch UI overview), a fourth task (e.g., pass UI overview quiz), a fifth task (e.g., watch team and user management training videos), and a sixth task (e.g., pass user and team management quiz).

The first task group (i.e., FIG. 15A) may further include one or more automated tasks or actions. In some examples, the system or platform is configured to automatically initiate an Onboard Enterprise SOC Team Runbook or Playbook (shown by Onboard Ent. SOC Team RB), which may include receiving information related to the SOC manager, where the information may include user credentials information (e.g., usemame, password), a first name, a last name, a full name, email address, and/or phone number for the SOC Manager. Next, the system is configured to execute the first task (i.e., Create Enterprise SOC Team) and the second task (i.e., Add SOC Manager to SOC Team), based at least in part on receiving the information related to the SOCManager. The system may also automatically create the third through sixth tasks of the first task group and assign those tasks to the Enterprise SOC Team.

The second task group (i.e., FIG. 15B) may comprise a plurality of tasks, including a first task (e.g., Create Enterprise IT Team), a second task (e.g., Add Network Admins to IT Team), a third task (e.g., Add CloudAdmins to IT Team), a fourth task (e.g., watch Admin Overview video), and a fifth task (e.g., pass Admin Overview Quiz). In this example, the second task group may have a dependency on the first task group.

The second task group (i.e., FIG. 15B) may further include one or more automated tasks or actions. In some examples, the system or platform is configured to automatically initiate an Onboard Enterprise IT Team Runbook or Playbook. Next, the system is configured to execute the first task (i.e., Create Enterprise IT Team) using the relevant enterprise IT Team settings. The system may also automatically create the second and third tasks of the second task group and assign them to the Enterprise SOC Team. In some cases, the system/platform may also automatically create the fourth and fifth tasks of the second task group and assign those tasks to the Enterprise IT Team.

The third task group (i.e., FIG. 15C) may comprise a first task (e.g., deploy on-prem collectors), a second task (e.g., deploy cloud collectors), and a third task (e.g., verify collectors are deployed). In this example, the third task group has a dependency on the second task group (i.e., shown in FIG. 15B).

The fourth task group (i.e., FIG. 15D) may comprise a first task (e.g., register enterprise), a second task (e.g., share customer ID with enterprise IT team), a third task (e.g., automatically rollout cybersecurity agent), and a fourth tasks (e.g., verify cybersecurity agent is onboarded). In this example, the fourth task group has a dependency on the second task group (i.e., FIG. 15B).

The fifth task group (i.e., FIG. 15E) may comprise a first task (e.g., collect on-prem firewall logs), a second task (e.g., collect cloud firewall logs), and a third task (e.g., verify firewall logs are collected). Furthermore, the fifth task group may have dependencies on the second task group and the third task group, shown in FIGS. 15B and 15C, respectively.

The sixth task group (i.e., FIG. 15F) may comprise a first task (e.g., collect cloud infrastructure logs) and a second task (e.g., verify cloud infrastructure logs are collected). Similar to the fifth task group, in this example, the sixth task group has dependencies on the second and third task groups.

The seventh task group (i.e., FIG. 15G) may also have dependencies on the second and third task groups, shown in FIGS. 15B and 15C, respectively. Furthermore, the seventh task group may comprise a first task (e.g., create enterprise security leadership team), a second task (e.g., add SOC managers to leadership team), a third task (e.g., create enterprise security analyst team), a fourth task (e.g., onboard security leadership users or team members), a fifth task (e.g., onboard security analysts), a sixth task (e.g., onboard restricted analysts), a seventh task (e.g., view executive overview video), and an eighth task (e.g., view workflow overview video).

The eighth task group (i.e., FIG. 15H) may have a dependency on the seventh task group (i.e., shown in FIG. 15G). Additionally, in this example, the eighth task group includes a first task (e.g., verify health status of enterprise deployment), a second task (e.g., run an Attack simulation), a third task (e.g., run a Vulnerability simulation), and a fourth task (e.g., enable Active Operations for the enterprise).

In this way, aspects of the present disclosure enable the creation of a library (e.g., shown as library object 1202 in FIG. 12) of pre-fabricated work items (i.e., work item templates, such as template task 1212 in FIG. 12) along with ad-hoc work items, where the work items can be assigned to one more tenants (e.g., shown as tenant 1201 in FIG. 12), and where the work is automatically pushed (or sent) to the appropriate team members (i.e., team members authorized to do the work). In some embodiments, the system of the present disclosure is configured to automatically assign the work items based on the assigned work type and/or the work-type-to-team association. As used herein, the term “work-type-to-team association” refers to the association of a work type (e.g., work type 1207 in FIG. 12) and a team (e.g., team 1205) authorized to perform work items of said work type. In some embodiments, the system of the present disclosure also allows a user to assign specific rights to different teams, herein referred to as “team rights”. In some aspects, team rights can be used to control what team member(s) of a particular team are authorized to do (e.g., take ownership of, transfer ownership of, collaborate on, only read or view, read and right privileges, etc.) when assigned a work item. In some cases, teams can be created to serve or perform work of specific types, at certain tiers. Furthermore, when instances of work are created (either ad-hoc or via libraries), the system of the present disclosure is configured to automatically route each work instance to the correct Team(s) and their members.

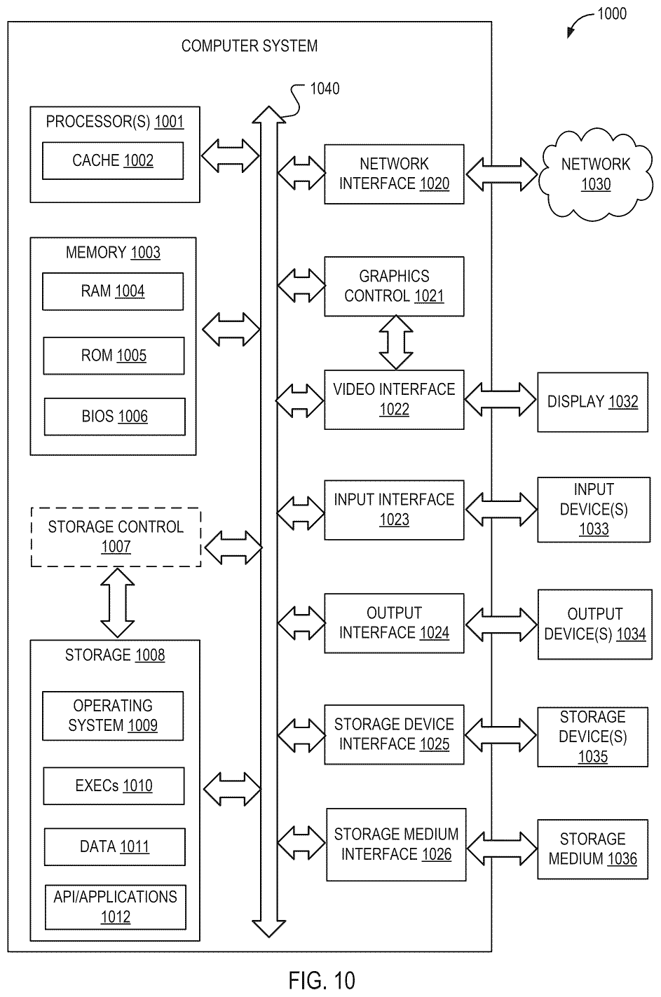

FIG. 10 illustrates a diagrammatic representation of one embodiment of a computer system 1000, within which a set of instructions can execute for causing a device to perform or execute any one or more of the aspects and/or methodologies of the present disclosure. The components in FIG. 10 are examples only and do not limit the scope of use or functionality of any hardware, software, firmware, embedded logic component, or a combination of two or more such components implementing particular embodiments of this disclosure. Some or all of the illustrated components can be part of the computer system 1000. For instance, the computer system 1000 can be a general-purpose computer (e.g., a laptop computer) or an embedded logic device (e.g., an FPGA), to name just two non-limiting examples.

Moreover, the components may be realized by hardware, firmware, software or a combination thereof. Those of ordinary skill in the art in view of this disclosure will recognize that if implemented in software or firmware, the depicted functional components may be implemented with processor-executable code that is stored in a non-transitory, processor-readable medium such as non-volatile memory. In addition, those of ordinary skill in the art will recognize that hardware such as field programmable gate arrays (FPGAs) may be utilized to implement one or more of the constructs depicted herein.

Computer system 1000 includes at least a processor 1001 such as a central processing unit (CPU) or a graphics processing unit (GPU) to name two non-limiting examples. Any of the subsystems described throughout this disclosure could embody the processor 1001. The computer system 1000 may also comprise a memory 1003 and a storage 1008, both communicating with each other, and with other components, via a bus 1040. The bus 1040 may also link a display 1032, one or more input devices 1033 (which may, for example, include a keypad, a keyboard, a mouse, a stylus, etc.), one or more output devices 1034, one or more storage devices 1035, and various non-transitory, tangible computer-readable storage media 1036 with each other and/or with one or more of the processor 1001, the memory 1003, and the storage 1008. All of these elements may interface directly or via one or more interfaces or adaptors to the bus 1040. For instance, the various non-transitory, tangible computer-readable storage media 1036 can interface with the bus 1040 via storage medium interface 1026. Computer system 1000 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 1001 (or central processing unit(s) (CPU(s))) optionally contains a cache memory unit 1002 for temporary local storage of instructions, data, or computer addresses. Processor(s) 1001 are configured to assist in execution of computer-readable instructions stored on at least one non-transitory, tangible computer-readable storage medium. Computer system 1000 may provide functionality as a result of the processor(s) 1001 executing software embodied in one or more non-transitory, tangible computer-readable storage media, such as memory 1003, storage 1008, storage devices 1035, and/or storage medium 1036 (e.g., read only memory (ROM) 1005).

Memory 1003 may read the software from one or more other non-transitory, tangible computer-readable storage media (such as mass storage device(s) 1035, 1036) or from one or more other sources through a suitable interface, such as network interface 1020. Any of the subsystems herein disclosed could include a network interface such as the network interface 1020. The software may cause processor(s) 1001 to carry out one or more processes or one or more steps of one or more processes described or illustrated herein, such as the method(s) 200 described in relation to FIGS. 2A-2F. Carrying out such processes or steps may include defining data structures stored in memory 1003 and modifying the data structures as directed by the software. In some embodiments, an FPGA can store instructions for carrying out functionality as described in this disclosure. In other embodiments, firmware includes instructions for carrying out functionality as described in this disclosure.

The memory 1003 may include various components (e.g., non-transitory, tangible computer-readable storage media) including, but not limited to, a random-access memory component (e.g., RAM 1004) (e.g., a static RAM “SRAM”, a dynamic RAM “DRAM, etc.), a read-only component (e.g., ROM 1005), and any combinations thereof. ROM 1005 may act to communicate data and instructions unidirectionally to processor(s) 1001, and RAM 1004 may act to communicate data and instructions bidirectionally with processor(s) 1001. ROM 1005 and RAM 1004 may include any suitable non-transitory, tangible computer-readable storage media. In some instances, ROM 1005 and RAM 1004 include non-transitory, tangible computer-readable storage media for carrying out a method, such as method(s) 200 described in relation to FIGS. 2A-2F. In one example, a basic input/output system (BIOS) 1006, including basic routines that help to transfer information between elements within computer system 1000, such as during start-up, may be stored in the memory 1003.

Fixed storage 1008 is connected bi-directionally to processor(s) 1001, optionally through storage control unit 507. Fixed storage 508 provides additional data storage capacity and may also include any suitable non-transitory, tangible computer-readable media described herein. Storage 1008 may be used to store operating system 1003, EXECs 1010 (executables), data 1011, API applications 1012 (application programs), and the like. Often, although not always, storage 1008 is a secondary storage medium (such as a hard disk) that is slower than primary storage (e.g., memory 1003). Storage 1008 can also include an optical disk drive, a solid-state memory device (e.g., flash-based systems), or a combination of any of the above. Information in storage 1008 may, in appropriate cases, be incorporated as virtual memory in memory 1003.

In one example, storage device(s) 1035 may be removably interfaced with computer system 1000 (e.g., via an external port connector (not shown)) via a storage device interface 1025. Particularly, storage device(s) 1035 and an associated machine-readable medium may provide nonvolatile and/or volatile storage of machine-readable instructions, data structures, program modules, and/or other data for the computer system 1000. In one example, software may reside, completely or partially, within a machine-readable medium on storage device(s) 1035. In another example, software may reside, completely or partially, within processor(s) 1001.

Bus 1040 connects a wide variety of subsystems. Herein, reference to a bus may encompass one or more digital signal lines serving a common function, where appropriate. Bus 1040 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1000 may also include an input device 1033. In one example, a user of computer system 1000 may enter commands and/or other information into computer system 1000 via input device(s) 1033. Examples of an input device(s) 1033 include, but are not limited to, an alpha-numeric input device (e.g., a keyboard), a pointing device (e.g., a mouse or touchpad), a touchpad, a touch screen and/or a stylus in combination with a touch screen, and any combinations thereof. Input device(s) 1033 may be interfaced to bus 1040 via any of a variety of input interfaces 1023 (e.g., input interface 1023) including, but not limited to, serial, parallel, game port, USB, FIREWIRE, THUNDERBOLT, or any combination of the above.

In particular embodiments, when computer system 1000 is connected to network 1030, computer system 1000 may communicate with other devices, such as mobile devices, IoT devices, servers, and/or enterprise systems, connected to network 1030. Communications to and from computer system 1000 may be sent through network interface 1020. For example, network interface 1020 may receive incoming communications (such as requests or responses from other devices, for instance, user instructions or commands, query requests, etc., from a user device) in the form of one or more packets (such as Internet Protocol (IP) packets) from network 1030, and computer system 1000 may store the incoming communications in memory 1003 for processing. Computer system 1000 may similarly store outgoing communications (such as requests or responses to other devices, a response to a user's query request, a request to the data store for links or dependencies between WITs, TGs, etc.) in the form of one or more packets in memory 1003 and communicated to network 1030 from network interface 1020. Processor(s) 1001 may access these communication packets stored in memory 1003 for processing.

Examples of the network interface 1020 include, but are not limited to, a network interface card, a modem, and any combination thereof. Examples of a network 1030 or network segment 1030 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 1030, may employ a wired and/or a wireless mode of communication. In general, any network topology known and/or contemplated in the art may be used.

Information and data can be displayed through a display 1032. Examples of a display 1032 include, but are not limited to, a liquid crystal display (LCD), an organic liquid crystal display (OLED), a cathode ray tube (CRT), a plasma display, and any combinations thereof. The display 1032 can interface to the processor(s) 1001, memory 1003, and fixed storage 1008, as well as other devices, such as input device(s) 1033, via the bus 1040. The display 1032 is linked to the bus 1040 via a video interface 1022, and transport of data between the display 1032 and the bus 1040 can be controlled via the graphics control 1021.

In addition to a display 1032, computer system 1000 may include one or more other peripheral output devices 1034 including, but not limited to, an audio speaker, a printer, etc. Such peripheral output devices may be connected to the bus 1040 via an output interface 1024. Examples of an output interface 1024 include, but are not limited to, a serial port, a parallel connection, a USB port, a FIREWIRE port, a THUNDERBOLT port, and any combinations thereof.

In addition, or as an alternative, computer system 1000 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an integrated circuit or IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, a software module implemented as digital logic devices, or in a combination of these. A software module may reside in RAM memory (e.g., RAM 1004), flash memory, ROM memory (e.g., ROM 1005), EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor 1001 (also shown as processor 134 in FIG. 1) such that the processor 1001 can read information from, and write information to, the non-transitory, tangible computer-readable storage medium. In the alternative, the non-transitory, tangible computer-readable storage medium may be integral to the processor 1001. The processor 1001 and the non-transitory, tangible computer-readable storage medium may reside in an ASIC. In some examples, the ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

It is contemplated that one or more of the components or subcomponents described in relation to the computer system 1000 shown in FIG. 10 such as, but not limited to, the network 1030, processor 1001, memory 1003, etc., may comprise a cloud computing system. In one such system, front-end systems such as input devices 1033 may provide information to back-end platforms such as servers (e.g., computer system(s) 100) and storage (e.g., memory 1003). Software (i.e., middleware) may enable interaction between the front-end and back-end systems, with the back-end system providing services and online network storage to multiple front-end clients. For example, a software-as-a-service (Saas) model may implement such a cloud-computing system. In such a system, users may operate software located on back-end servers through the use of a front-end software application such as, but not limited to, a web browser.

Processor 1001, also shown as processor 134 in FIG. 1, may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1001 may be configured to operate a memory array using a memory controller. In other cases, a memory controller may be integrated into the processor. The processor 1001 or processor 134 may be configured to execute computer-readable instructions stored in memory to perform various functions. Memory 1003, also shown as electronic storage 132 in FIG. 1, may include random access memory (RAM) and read only memory (ROM). The memory may store computer- readable, computer-executable software including instructions that, when executed, cause the processor 1001 to perform various functions described herein. In some cases, the memory may contain, among other things, a basic input/output system (BIOS) which may control basic hardware and/or software operation such as the interaction with peripheral components or devices.

Software may include code to implement aspects of the present disclosure, including code for creating and/or managing a multi-tenant and multi-tier managed work architecture using a computing platform (e.g., system 100 in FIG. 1). Software may be stored in a non-transitory computer-readable medium such as system memory or other memory. In some cases, the software may not be directly executable by the processor but may cause a computer (e.g., when compiled and executed) to perform functions described herein.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for automated workflow management in a protected environment using a computing platform, the system comprising:
one or more hardware processors configured by machine-readable instructions to:
identify, for the protected environment, a plurality of tiers, including at least a first tier and a second tier lower than the first tier;
identify a plurality of tenants operating within the protected environment, wherein each of the plurality of tenants is associated with one of the plurality of tiers;
identify a plurality of work items (WIs);
identify one or more tasks to be performed for each work item (WI);
determine, for each of the plurality of WIs, at least a work item type; and
automatically assign each of the one or more tasks for each of the plurality of WIs to at least one entity, wherein the assigning is based at least in part on:
determining, for each of the one or more tasks, at least one entity for performing the respective task, wherein the determining the at least one entity for each of the one or more tasks is based on one or more of a tenant and a tier associated with the respective task, the respective work item type, or a combination thereof.

2. The system of claim 1, wherein the automatically assigning each of the one or more tasks to the at least one entity includes assigning each task to one of:
a respective tenant of the plurality of tenants,
a team associated with a respective one of the plurality of tiers,
a team associated with a respective one of the plurality of tenants,
a plurality of entities, including a first entity associated with the first tier and a second entity associated with the second tier, or
a specific entity associated with a respective one of the plurality of tenants.

3. The system of claim 1, wherein the one or more hardware processors are further configured to:
automatically record results of work performed, based at least in part on tracking one or more task metrics for each of the one or more tasks.

4. A method for automated workflow management in a protected environment using a computing platform, comprising:
identifying, for the protected environment, a plurality of tiers, including at least a first tier and a second tier lower than the first tier;
identifying a plurality of tenants operating within the protected environment, wherein each of the plurality of tenants is associated with one of the plurality of tiers;
identifying a plurality of work items (WIs);
identifying one or more tasks to be performed for each work item (WI);
determining, for each of the plurality of WIs, at least a work item type;
automatically assigning each of the one or more tasks for each of the plurality of WIs to at least one entity, wherein the assigning is based at least in part on:
determining, for each of the one or more tasks, at least one entity for performing the respective task, wherein the determining the at least one entity for each of the one or more tasks is based on one or more of a tenant and a tier associated with the respective task, the respective work item type, or a combination thereof.

5. The method of claim 4, wherein the automatically assigning each of the one or more tasks to the at least one entity includes assigning each task to one of:
a respective tenant of the plurality of tenants,
a team associated with a respective one of the plurality of tiers,
a team associated with a respective one of the plurality of tenants,
a plurality of entities, including a first entity associated with the first tier and a second entity associated with the second tier, or
a specific entity associated with a respective one of the plurality of tenants.

6. The method of claim 4, further comprising automatically recording results of work performed, based at least in part on tracking one or more task metrics for each of the one or more tasks.

7. The method of claim 4, further comprising:
identifying, for at least one task, one or more tasks that are related to or dependent on the at least one task.

8. The method of claim 4, further comprising:
creating, using the computing platform, a plurality of libraries, wherein each of the plurality libraries comprises at least one work item template (WIT) associated with at least one work item type;
assigning at least one of the plurality of libraries to each of the plurality of tiers.

9. The method of claim 8, further comprising:
creating, using the computing platform, a base WIT, wherein the base WIT is associated with a plurality of properties or features; and
constructing, using the computing platform, the at least one WIT for at least one of the plurality of libraries, wherein constructing the at least one WIT for the at least one of the plurality of libraries comprises:
extracting the plurality of properties or features from the base WIT, and
creating the at least one WIT, based on the extracting.

10. The method of claim 9, wherein the at least one WIT inherits the plurality of properties or features from the base WIT.

11. The method of claim 9, wherein,
the at least one WIT comprises a first WIT and a second WIT,
the first WIT associated with a first WI of the plurality of WIs,
the second WIT associated with a second WI of the plurality of WIs,
the first WI comprising a first child WI,
the second WI comprising a second child WI.

12. The method of claim 11, wherein the first WI is associated with a first work type and the second WI is associated with a second work type that is different from the first work type, and wherein the first child WI is associated with the first work type, and wherein the second child WI is associated with a third work type that is different from each of the first and second work types.

13. The method of claim 4, further comprising automatically assigning each of the plurality of WIs to one of a tier, a team, or a tenant.

14. The method of claim 4, wherein each of the plurality of tiers comprises one of a Platform tier, a virtual Security Operations Center (vSOC) tier, or an Enterprise tier, and wherein each of the plurality of tiers is associated with a plurality of work item types.

15. The method of claim 14, wherein,
the plurality of the work item types associated with the Platform tier include threat detection content, workflow content, security awareness training content, and data onboarding content,
the plurality of work item types associated with the vSOC tier include threat detection content, workflow content, security awareness training content, threat investigation, incident response, enterprise resiliency, and data onboarding content, and
the plurality of work item types associated with the Enterprise tier include threat investigation, incident response, human resources (HR) inquiries, legal inquiries, system administration, network administration, and user administration.

16. The method of claim 4, further comprising:
automatically creating, using the computing platform, one or more work item templates (WITs), wherein each WIT comprises data for creating at least one work item (WI), and wherein each WIT is selected from a group consisting of a task, an assessment, and a remediation.

17. The method of claim 16, wherein the one or more WITs comprises a first WIT and a second WIT, the method further comprising:
identifying a link between the first WIT and the second WIT, wherein the link comprises one of a parent-child link, a dependency link, and a reference link.

18. A non-transient computer-readable storage medium having instructions embodied thereon, the instructions being executable by one or more processors to perform a method for automated workflow management in a protected environment using a computing platform, the method comprising:
identifying, for the protected environment, a plurality of tiers, including at least a first tier and a second tier lower than the first tier;
identifying a plurality of tenants operating within the protected environment, wherein each of the plurality of tenants is associated with one of the plurality of tiers;
identifying a plurality of work items (WIs);
identifying one or more tasks to be performed for each work item (WI);
determining, for each of the plurality of WIs, at least a work item type;
automatically assigning each of the one or more tasks for each of the plurality of WIs to at least one entity, wherein the assigning is based at least in part on:
determining, for each of the one or more tasks, at least one entity for performing the respective task, wherein the determining the at least one entity for each of the one or more tasks is based on one or more of a tenant and a tier associated with the respective task, the respective work item type, or a combination thereof.

19. The non-transient computer-readable storage medium of claim 18, wherein the method further comprises automatically recording results of work performed, based at least in part on tracking one or more task metrics for each of the one or more tasks.

20. The non-transient computer-readable storage medium of claim 18, wherein the method further comprises:
creating, using the computing platform, a plurality of libraries, wherein each of the plurality libraries comprises at least one work item template (WIT) associated with at least one work item type;
assigning at least one of the plurality of libraries to each of the plurality of tiers.
